(19) United States
(12) Patent Application Publication
(10) Pub. No.: US 2006/0248520 A1
(43) Pub. Date: Nov. 2, 2006

(54) Program conversion device and program conversion method

(76) Inventors: Teruo Kawabata, Osaka (JP); Hajime Ogawa, Osaka (JP); Taketo Heishi, Osaka (JP); Yasuhiro Yamamoto, Kyoto (JP); Shohei Michimoto, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 10/565,530

(22) PCT Filed: Feb. 4, 2005
(86) PCT No.: PCT/JP05/01670

§ 371 Date: Jan. 23, 2006

(30) Foreign Application Priority Data
Feb. 12, 2004 (JP) 2004-035430

(51) Int. Cl. G06F 9/45

(52) U.S. Cl. 717/160

(57) ABSTRACT

A compiler which improves the processing speed of a program execution without needlessly issuing an instruction that has a possibility of causing an interlock is targeted at a processor having an instruction that has a possibility of causing an interlock when the instruction is executed, the compiler causing a computer to function as: a loop structure transforming unit (186) which performs double looping transformation on an input program so that a loop whose iteration count is y is split off from a loop whose loop count is x and the loop whose iteration count is y is an inner loop whereas a loop whose iteration count is x/y is an outer loop; and an instruction optimum placing unit (187) which places an instruction that has a possibility of causing an interlock in the program on which the double looping transformation has been performed.

### TECHNICAL FIELD

The present invention relates to a program conversion device, and in particular relates to a program conversion device for a processor which has an instruction set including an instruction that waits for a predetermined response from an outside source when the instruction is executed.

### BACKGROUND ART

In recent years, the processing speed of a processor has been significantly improved while, as compared with this, an improvement in the access speed of main memory is minor. The speed difference between them continues to grow year by year. On account of this, it has been conventionally pointed out that the memory access is a bottleneck in the high-speed processing performed by an information processing device.

In order to solve this problem, a cache organization has been used from the perspective of a storage hierarchy. When the cache organization is used, data which is requested by a processor is transferred beforehand (namely, prefetched) from main memory into a high speed cache. By means of this, it becomes possible to quickly correspond to the memory access from the processor.

However, when the processor attempts to access data that is not present in the cache, a cache miss will occur. Due to this, it will take time for the data to be transferred from the main memory into the cache.

It is assumed that if a user performs programming without keeping the cache in mind, such a cache miss would frequently occur when that program is executed. As a result, penalties due to the cache misses will significantly deteriorate performance of the processor. For this reason, a compiler needs to perform optimization in consideration of the cache.

One of the techniques for cache optimization is to insert prefetch instructions. A prefetch instruction is used for having data of a specific memory address previously transferred from main memory into a cache before the memory address is referenced. In the optimization employing the insertion of prefetch instructions, a prefetch instruction is to be inserted into a cycle slightly ahead of the cycle in which the memory address is referenced.

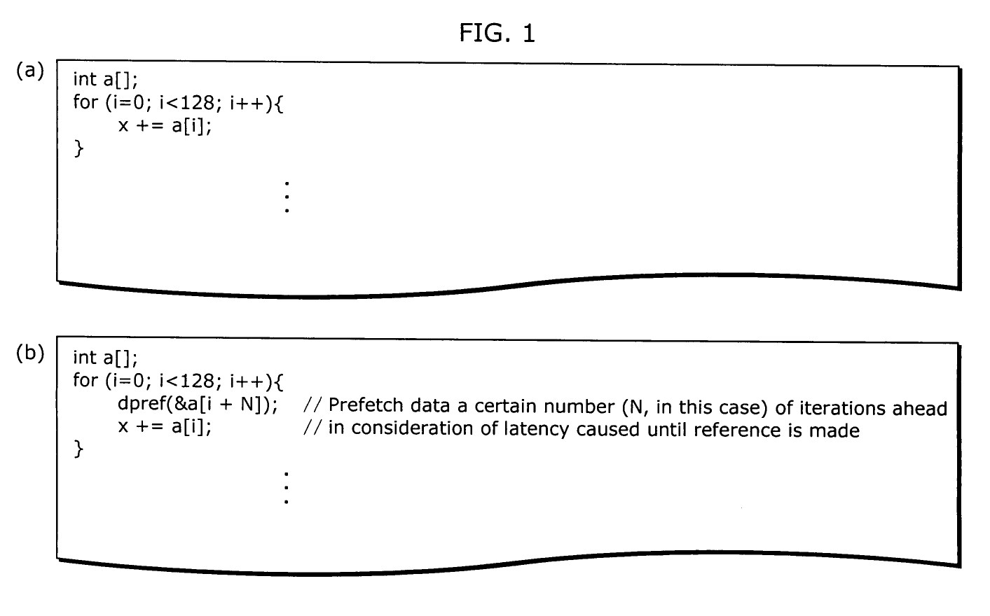

For example, in the case of loop processing shown in FIG. 1(a), a prefetch instruction (dpref( )) is inserted into the loop as shown in FIG. 1(b) so that the data to be referenced a few iterations later is prefetched in consideration of the latency time taken before the data is referenced. It should be noted here that an element of an array a of the “int” type is four bytes and that the cache line size is 128 bytes.

### DISCLOSURE OF INVENTION

Problems that Invention is to Solve

In code shown in FIG. 1(b), however, reference to the array a and prefetch are respectively performed per iteration. The reference is made in units of only four bytes while the prefetch is performed in units of one line (128 bytes).

In other words, one prefetch can correspond to 32 references, meaning that the remaining 31 prefetches are performed in vain. That is to say, it ends up repeatedly issuing the prefetch instruction of the same line.

Depending on processors, while a data transfer is being performed according to a dpref instruction and then a next dpref instruction is to be executed, the next dpref instruction is issued before the data transfer from the main memory to the cache according to the previous dpref instruction is finished. As such, an interlock will occur even though the dpref instruction was inserted to avoid such an interlock in the first place.

On that account, when one iteration of a loop is short and an interval between two dpref instructions is short as described in the above case, the time (latency) taken for the data to be transferred from the main memory to the cache according to the dpref instruction becomes conspicuous, more deteriorating the performance.

Also, aside from the execution of the dpref instruction, an instruction that causes a response waiting of some kind after the instruction is issued, such as a memory access instruction, have a possibility of causing an interlock.

The present invention was conceived in view of the problem described above, and has an object of providing a program conversion device and a program conversion method that improve the processing speed of a program execution without needlessly issuing instructions that have a possibility of causing an interlock.

Moreover, the present invention has an object of providing a program conversion device and a program conversion method that improve the processing speed of a program execution without needlessly issuing instructions that cause a response waiting of some kind after the instruction is issued.

Furthermore, the present invention has an object of providing a program conversion device and a program conversion method that cause no interlocks during the program execution.

Means to Solve the Problems

The stated object can be achieved by a program conversion device of the present invention for a processor which has an instruction set including an instruction that waits for a predetermined response from an outside source when the instruction is executed, the program conversion device being composed of: a loop structure transforming unit operable to perform double looping transformation so as to transform a structure of a loop, which is included in an input program and whose iteration count is x, into a nested structure where a loop whose iteration count is y is an inner loop and a loop whose iteration count is x/y is an outer loop; and an instruction placing unit operable to convert the input program into an output program including the instruction by placing the instruction in a position outside the inner loop.

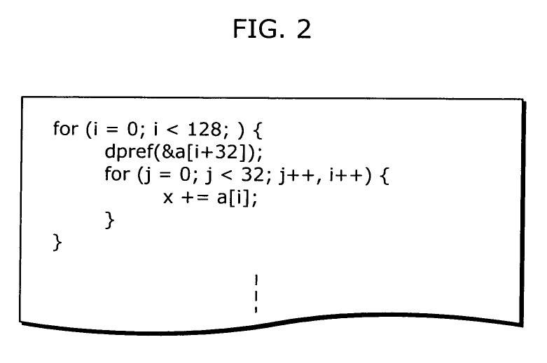

With this, as shown in FIG. 2, the loop processing shown in FIG. 1(a) can be transformed into a double loop and a prefetch instruction can be inserted outside the innermost loop. By doing so, no prefetches are needlessly executed and the processing speed is accordingly improved. It also becomes possible to hide latency taken for the data to be transferred from the main memory to the cache between the executions of one dpref instruction and a next dpref instruction. Thus, interlocks are less likely to occur.

More specifically, the present invention allows a loop to be transformed into a double loop so that an instruction having a possibility of causing an interlock is executed outside an inner loop. Consequently, the processing speed of the program execution can be improved without needless issues of the instruction.

Moreover, by means of the double loop, it becomes possible to ensure the number of cycles taken from the issue of an instruction that has a possibility of causing an interlock to the issue of a next instruction that has a possibly of causing another interlock. Thus, interlocks are less likely to occur during the program execution.

It should be noted that the program conversion device can be realized as a compiler, an OS (Operating System), or an integrated circuit, such as a CPU.

Response wait instructions include an instruction that might wait or not wait for a response as the case may be, as well as including an instruction that has a possibility of causing an interlock like the above-mentioned dpref instruction and an instruction that waits for a predetermined response from an outside source when the instruction is executed.

It should be noted here that the present invention may be realized not only as the program conversion device provided with such characteristic units, but also as: a program conversion method having steps corresponding to the characteristic units provided in the program conversion device; and a program that has a computer function as a program conversion device. Also, it should be understood that such a program can be distributed via a record medium such as a CD-ROM (Compact Disc-Read Only Memory), or via a transmission medium such as the Internet.

### EFFECTS OF THE INVENTION

The present invention can improve the processing speed of a program execution.

Moreover, interlocks are less likely to occur during the program execution.

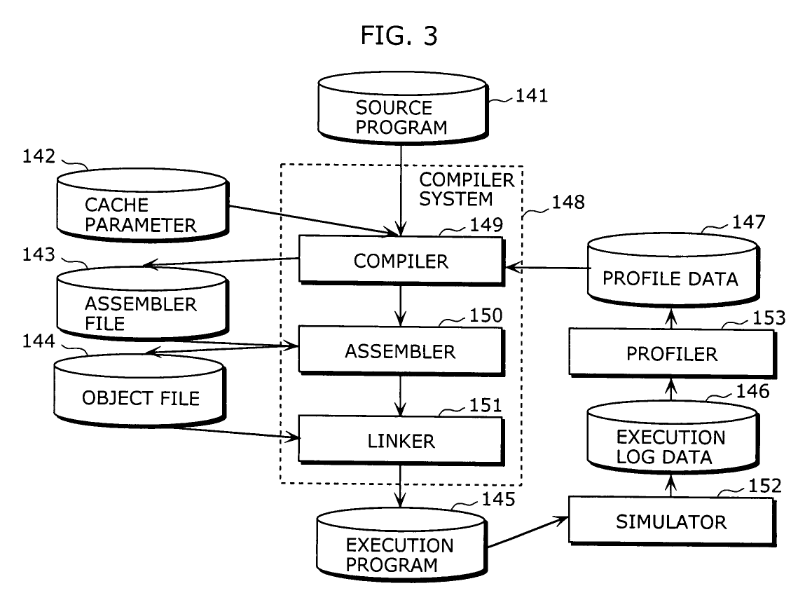

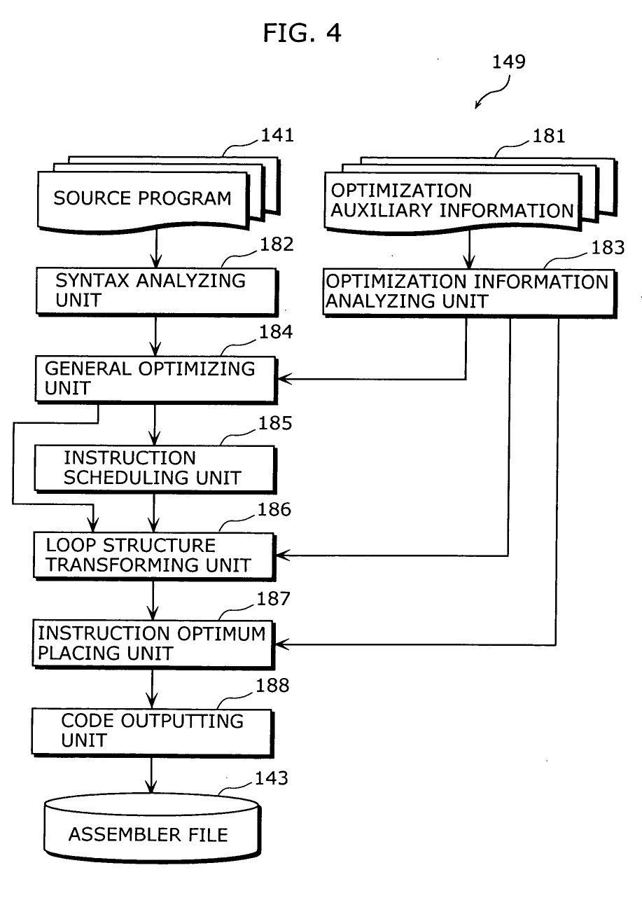

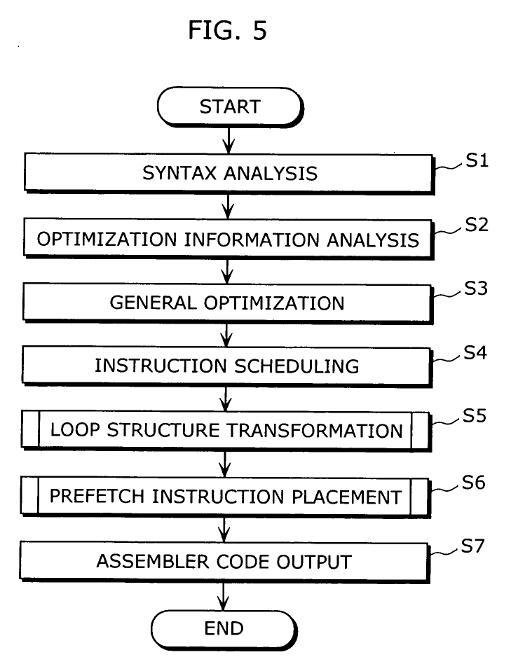

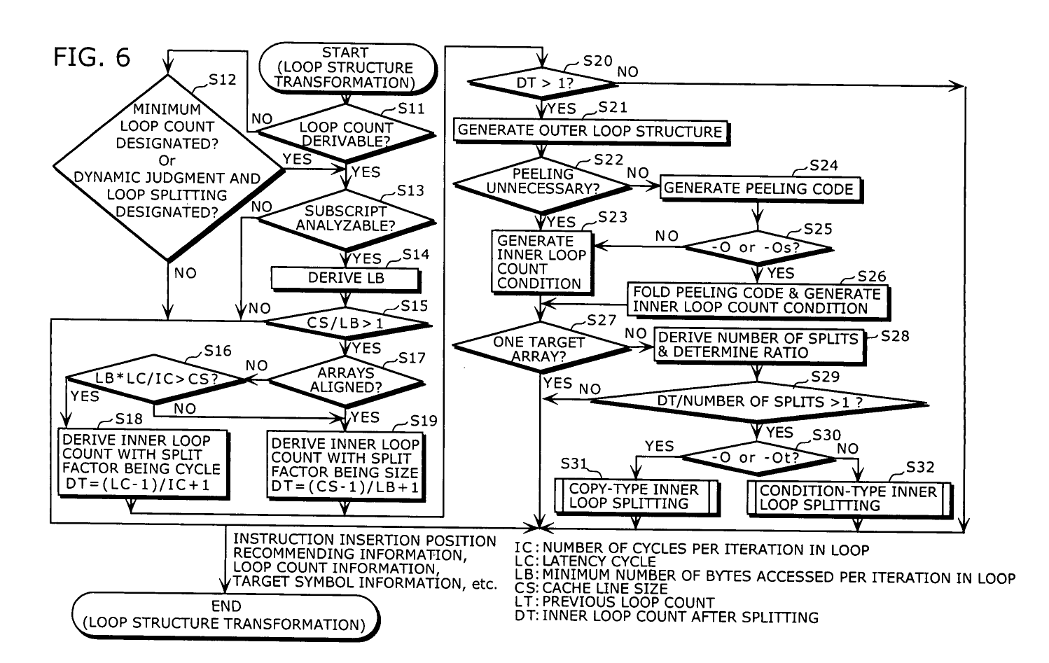

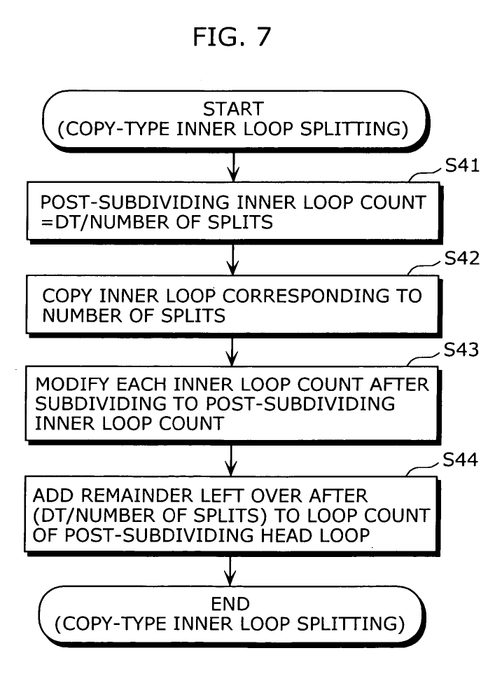

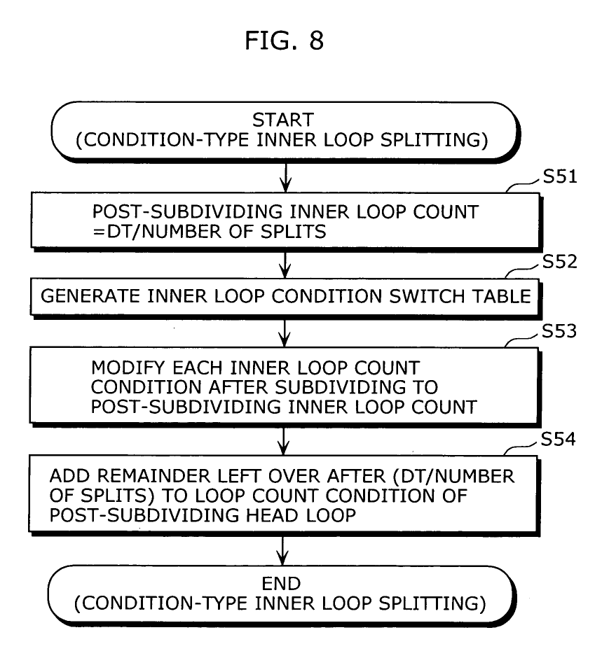

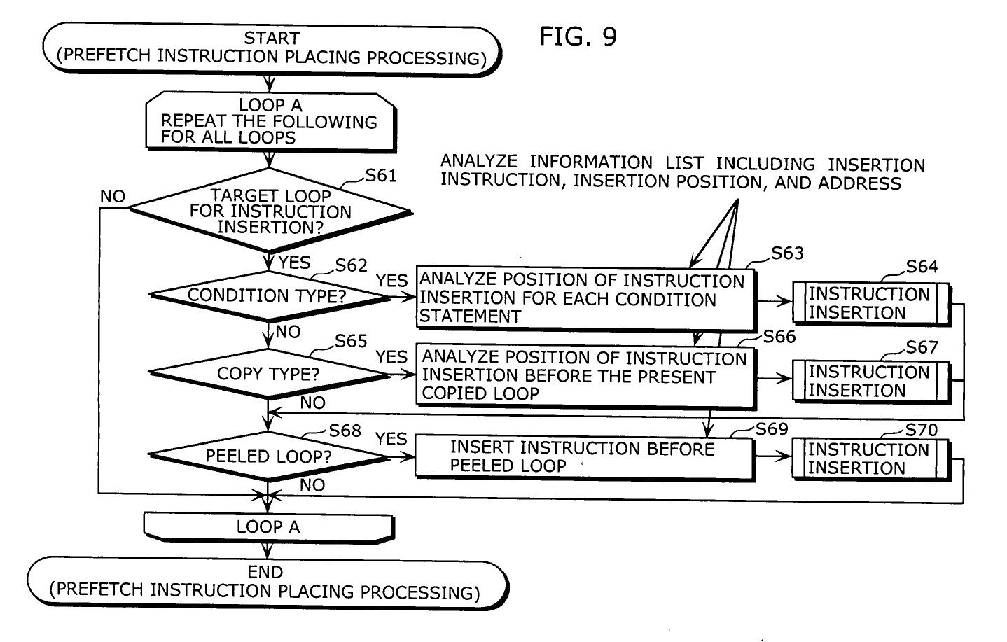

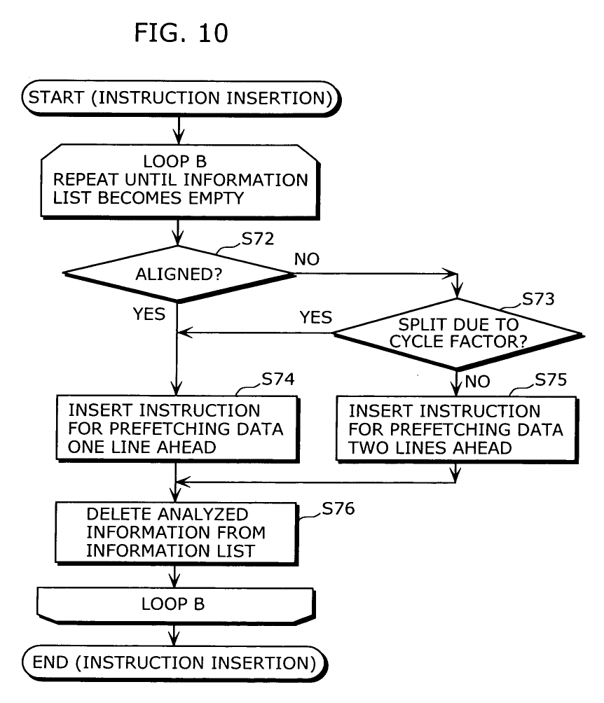

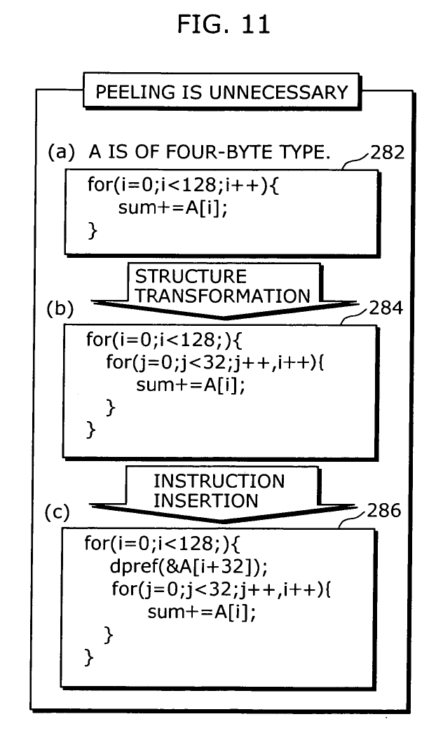

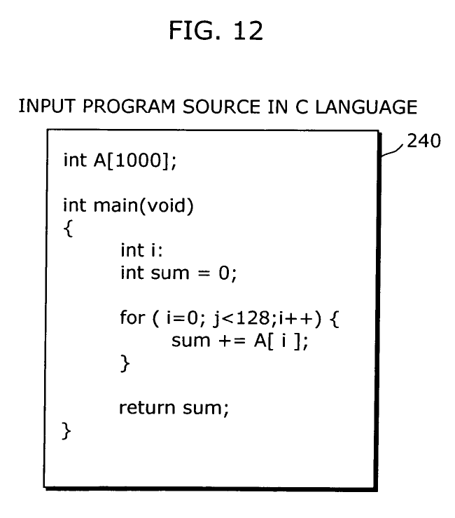

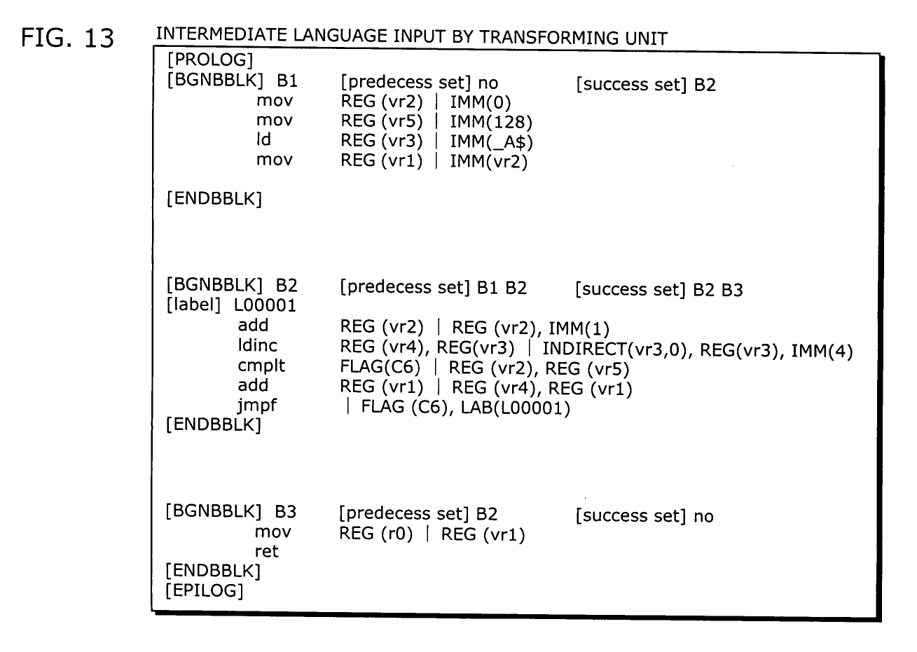

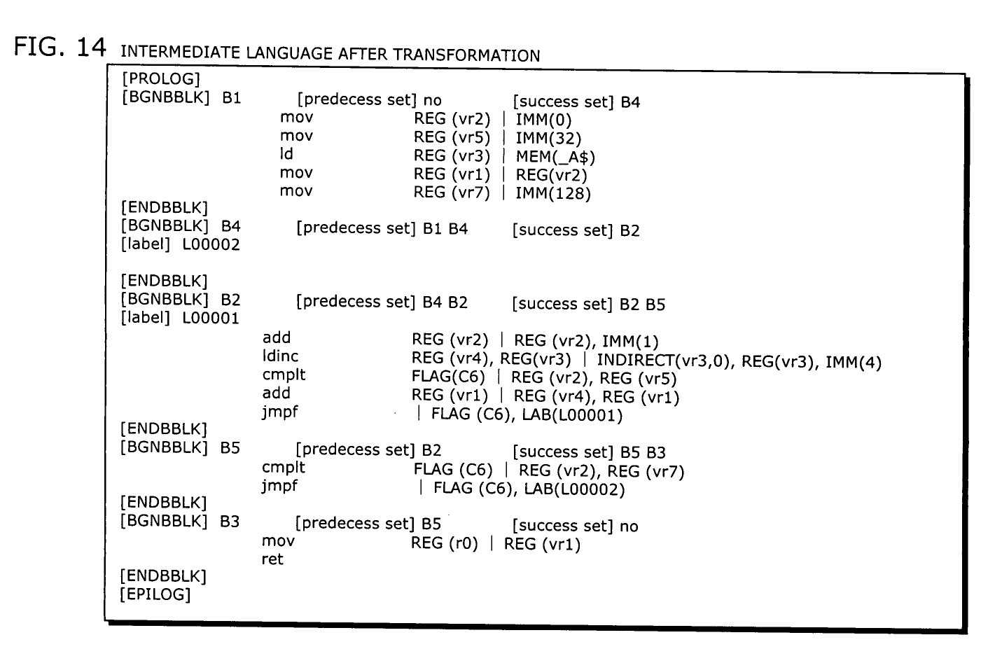

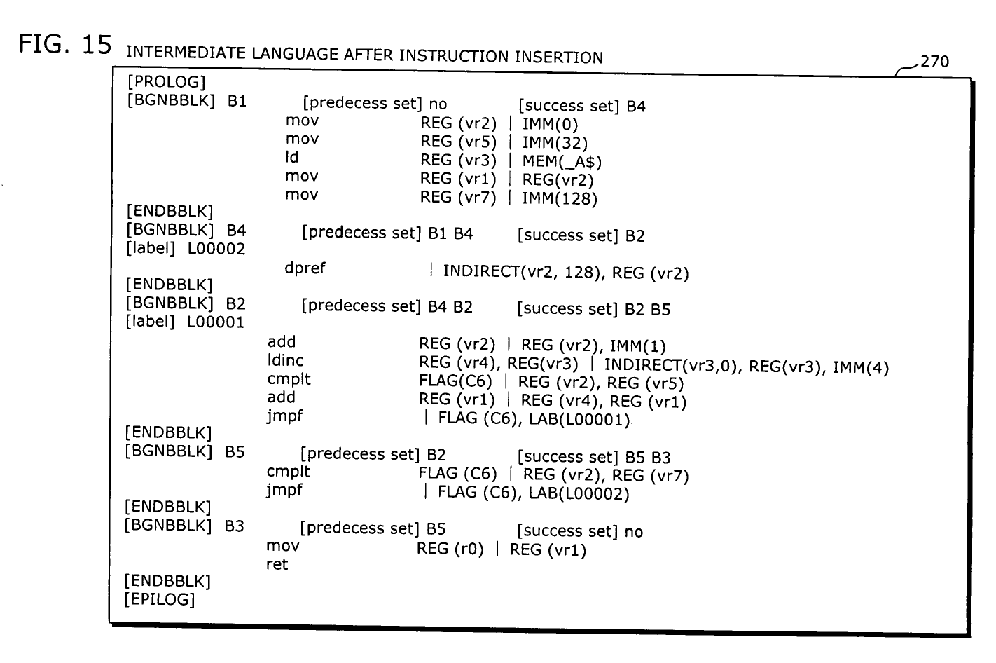

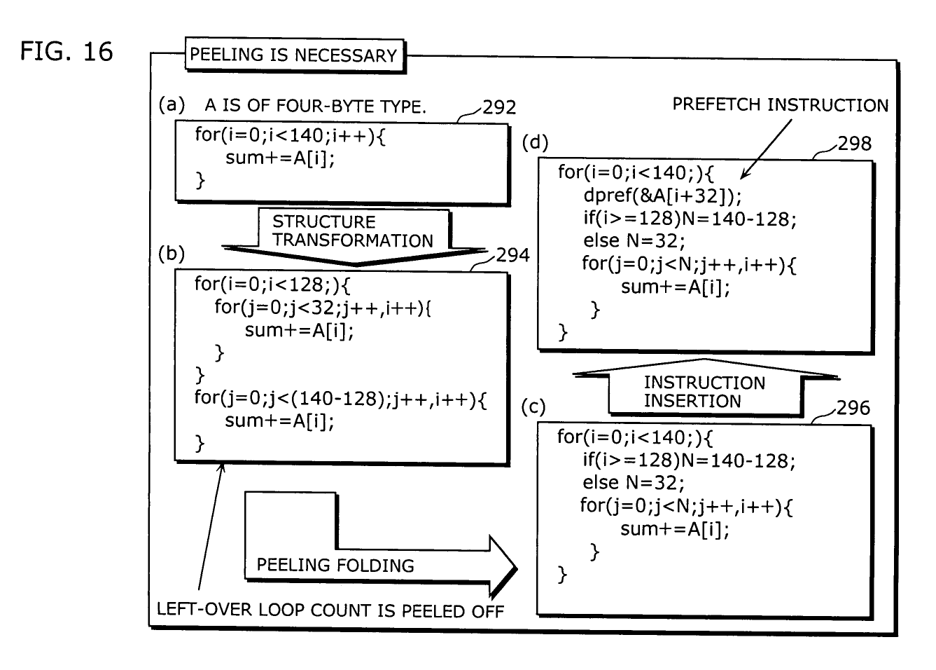

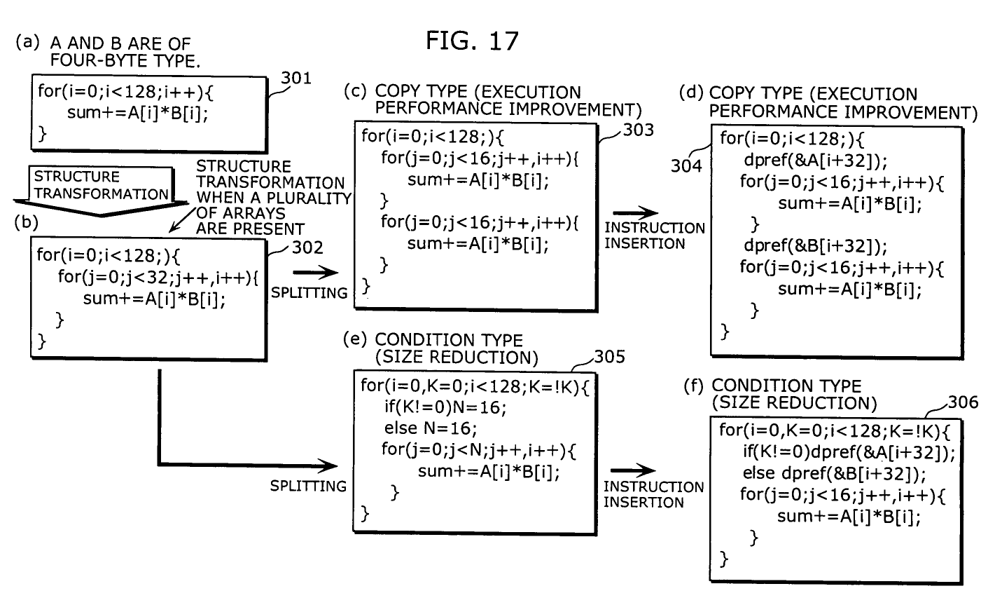

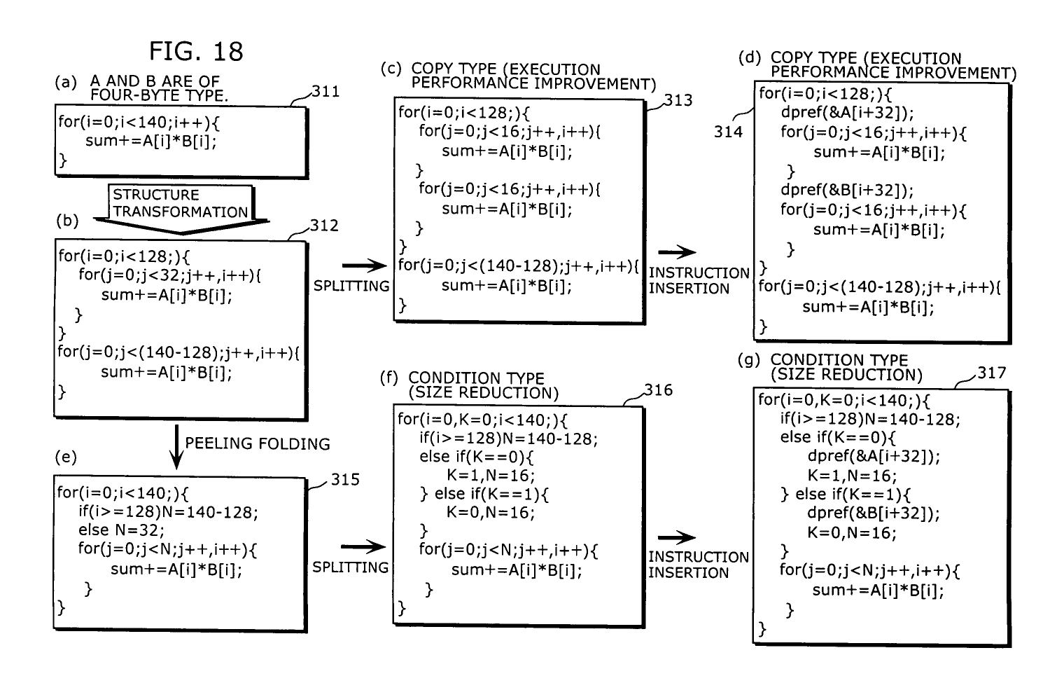

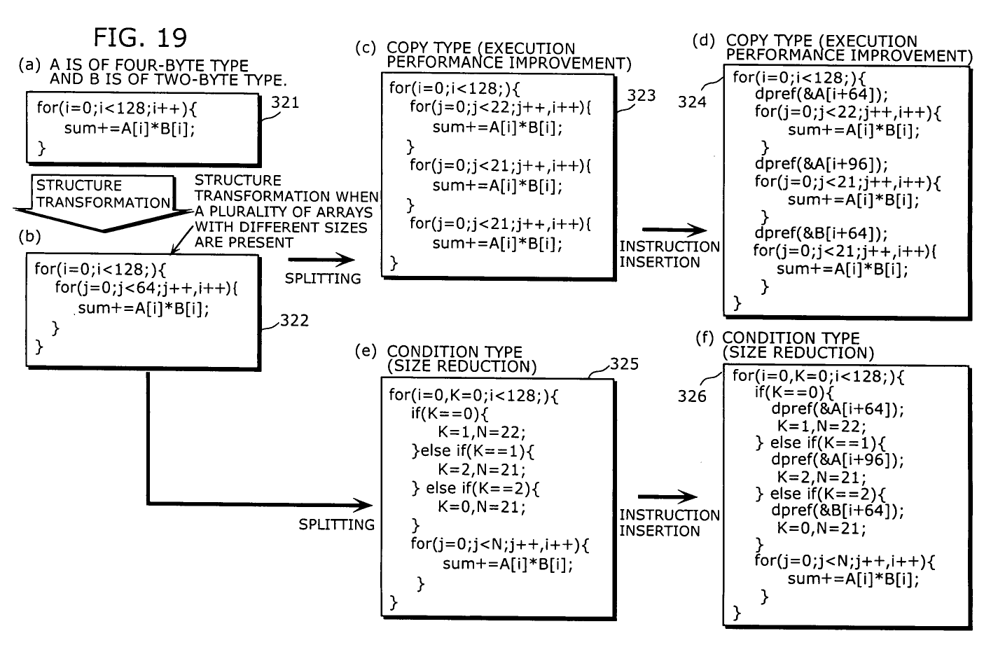

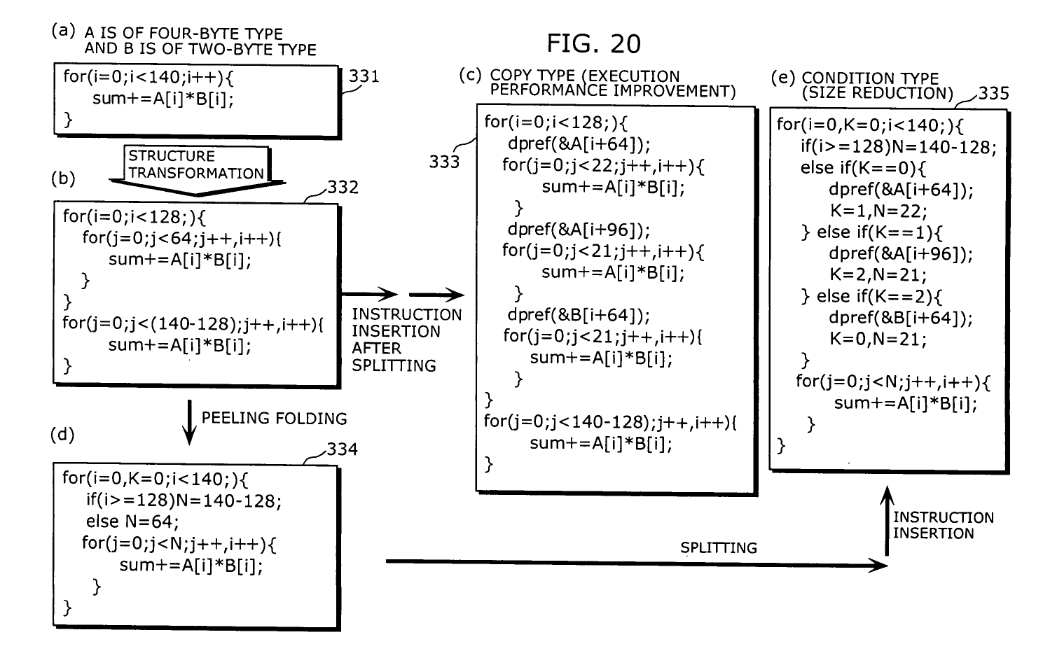

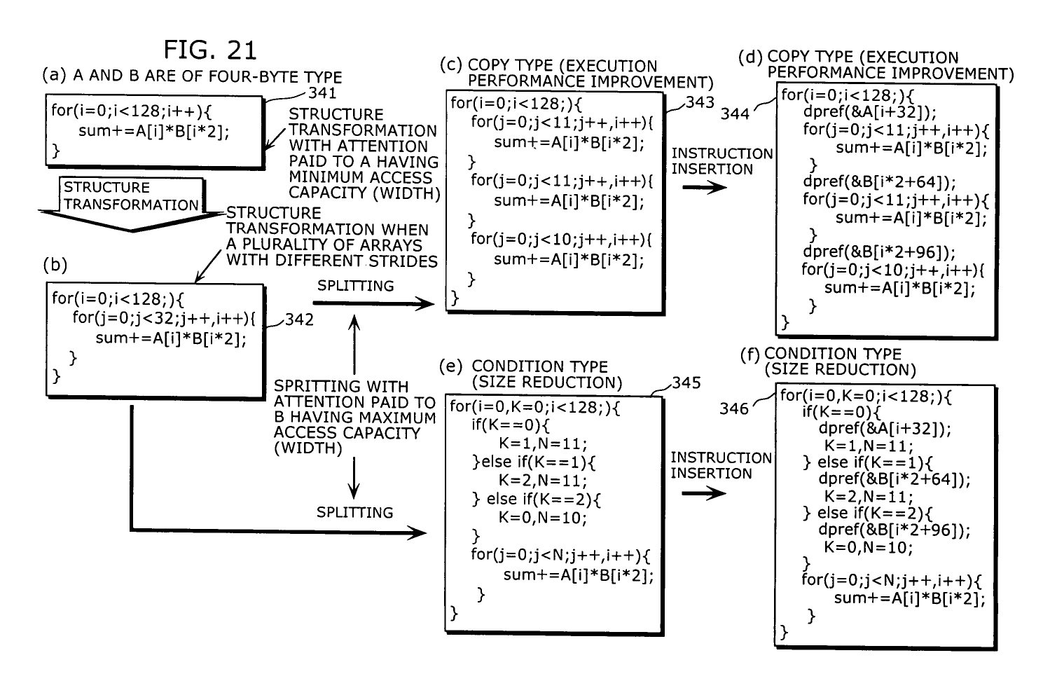

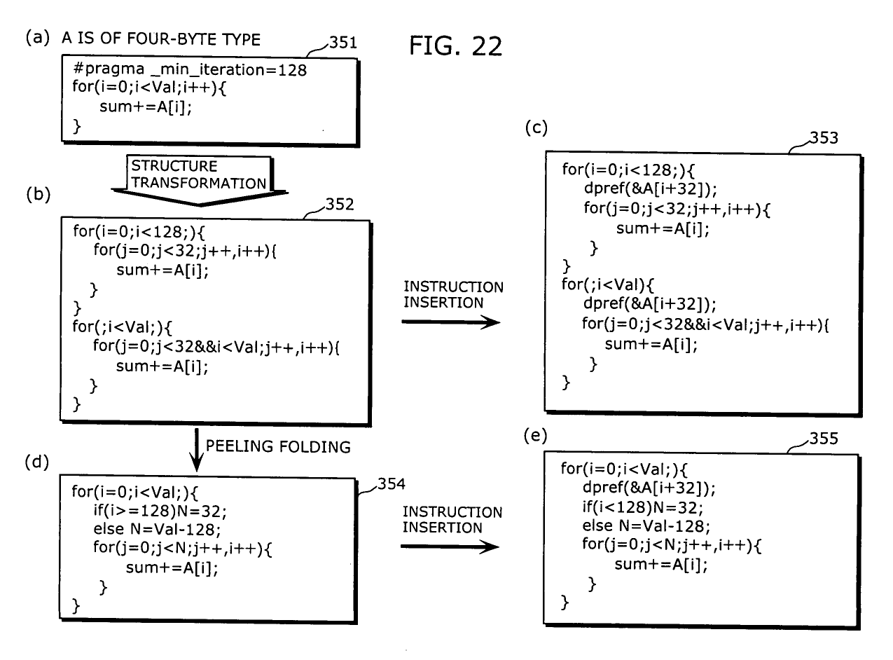

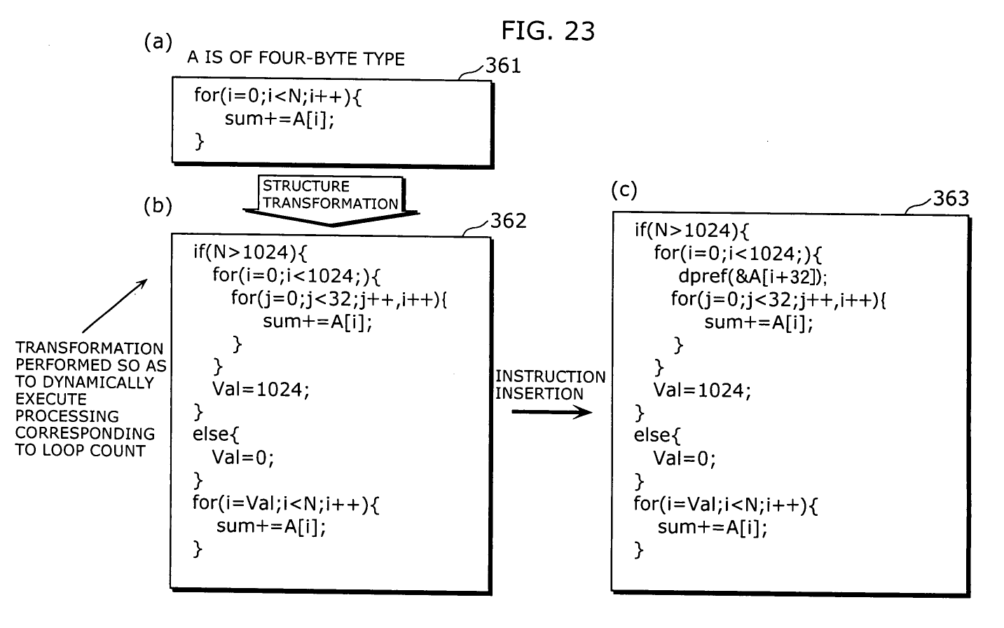

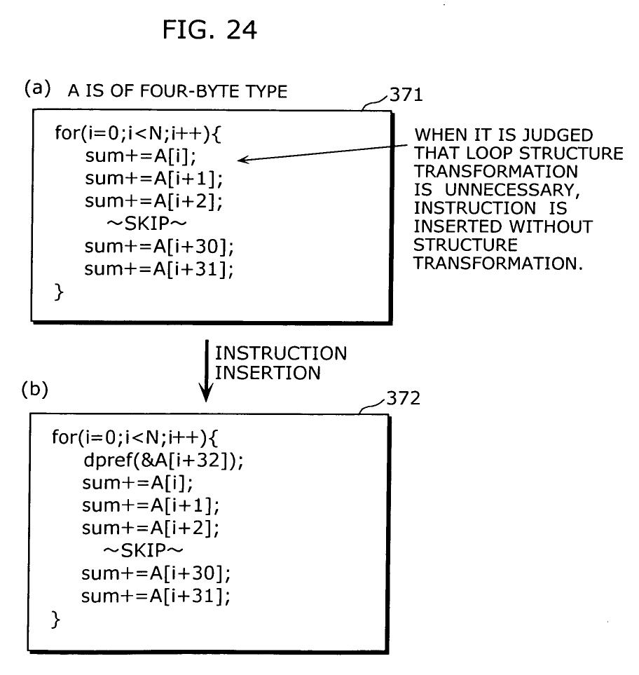

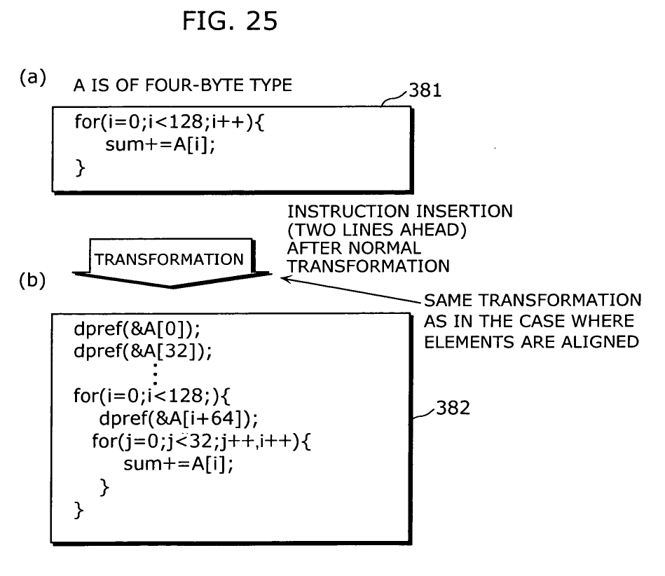

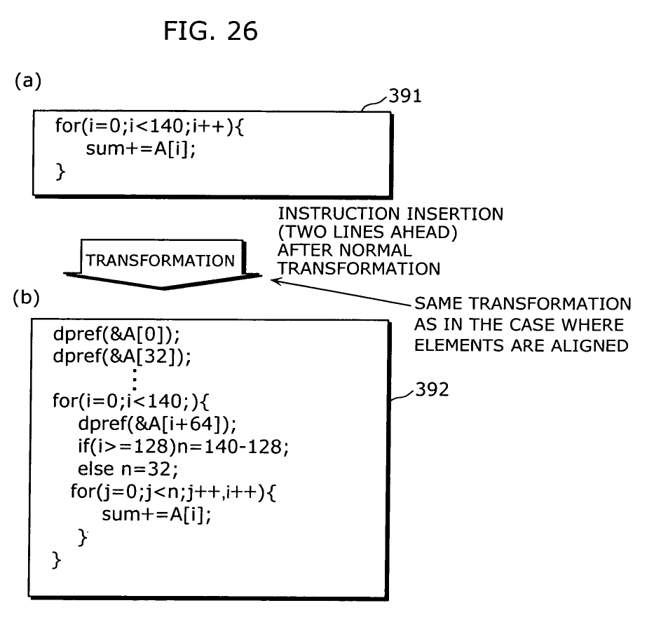

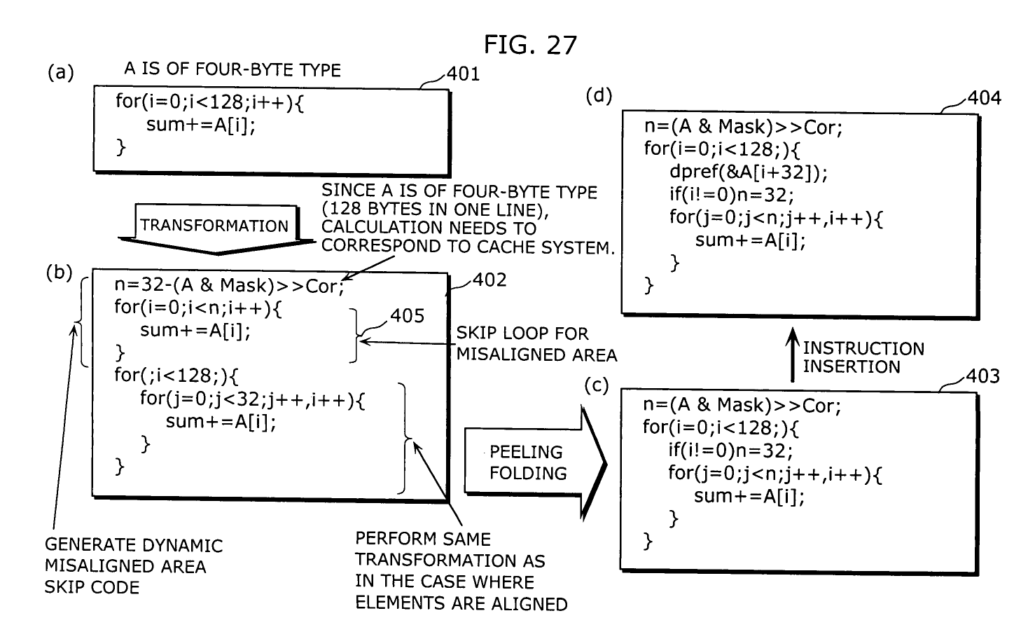

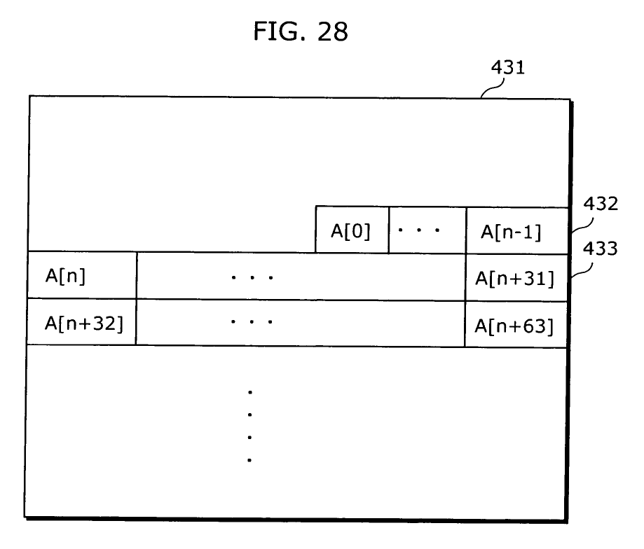

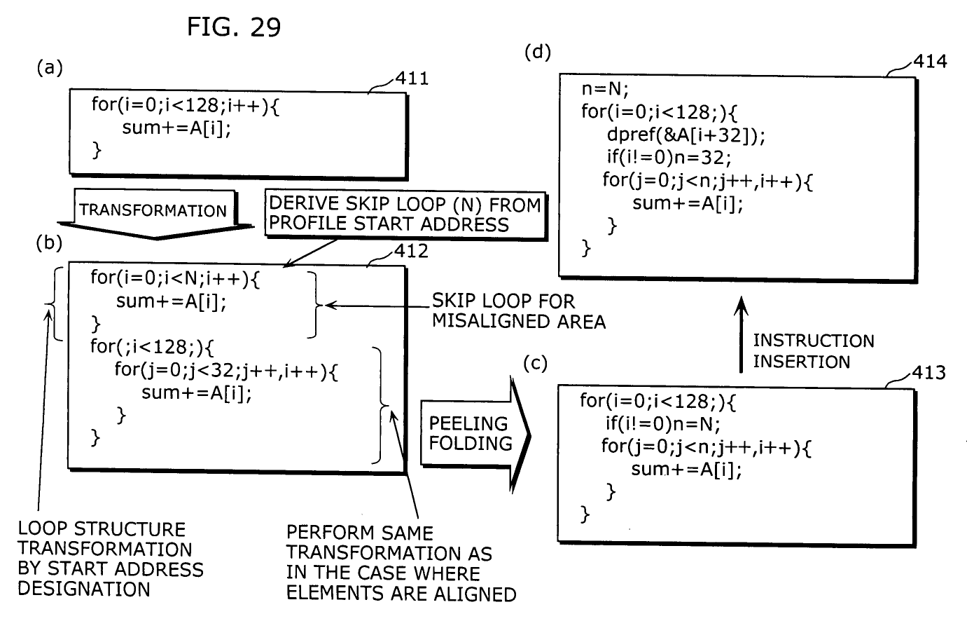

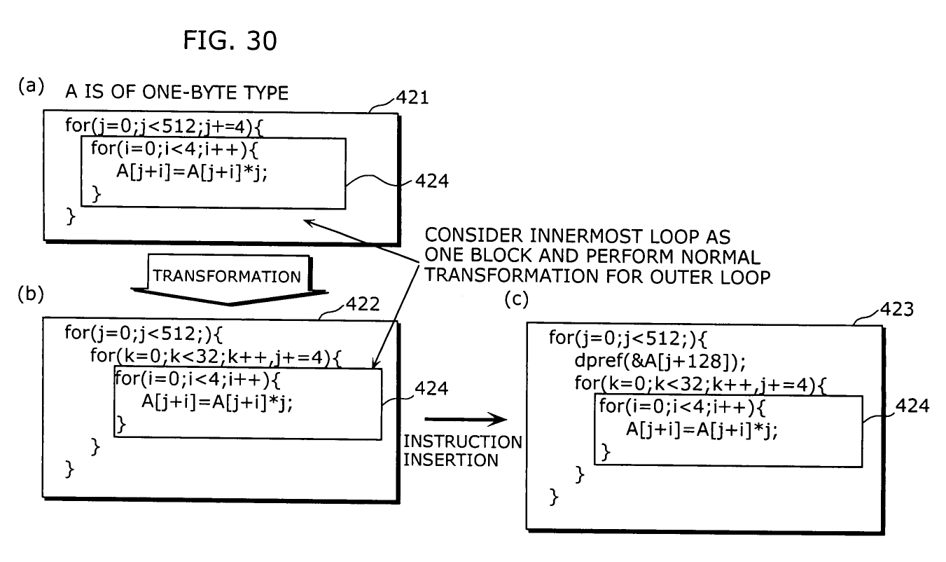

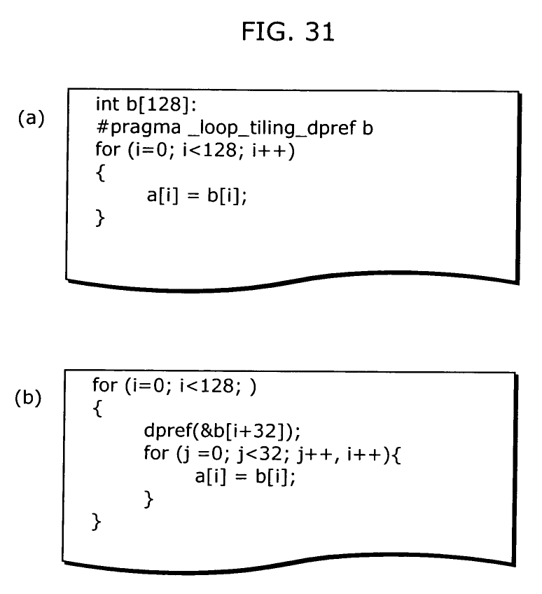

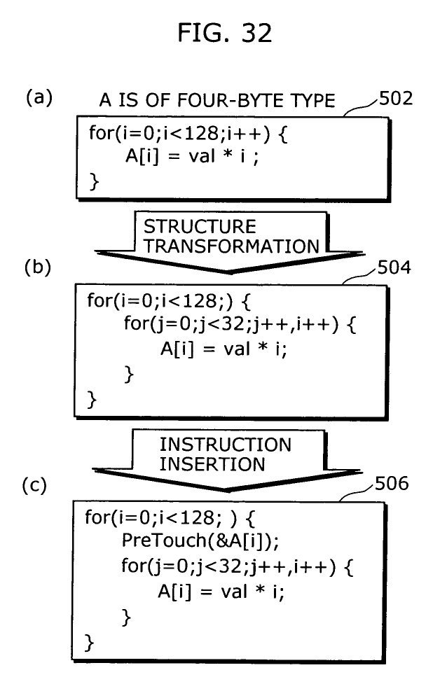

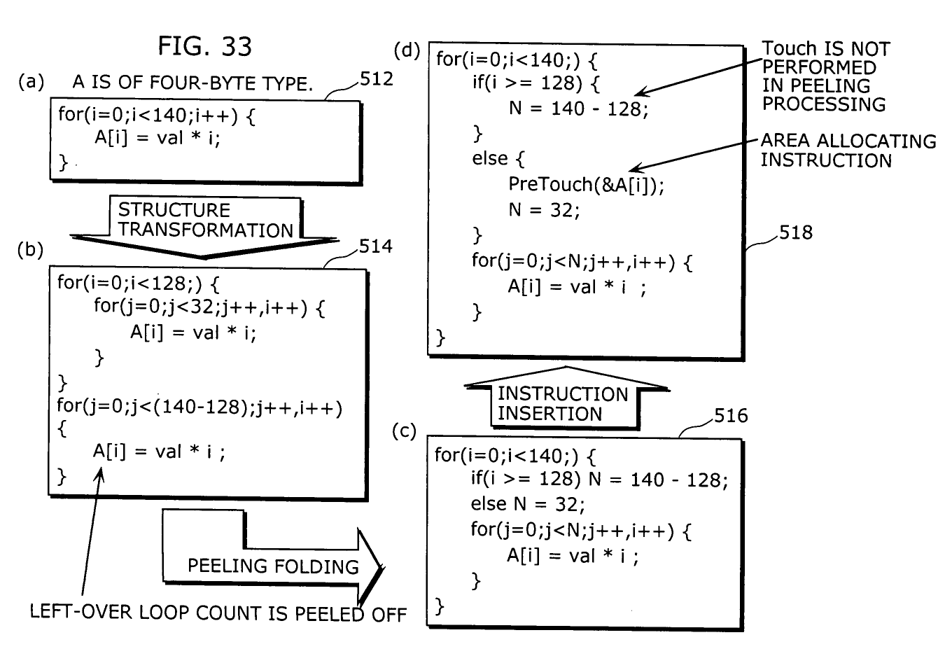

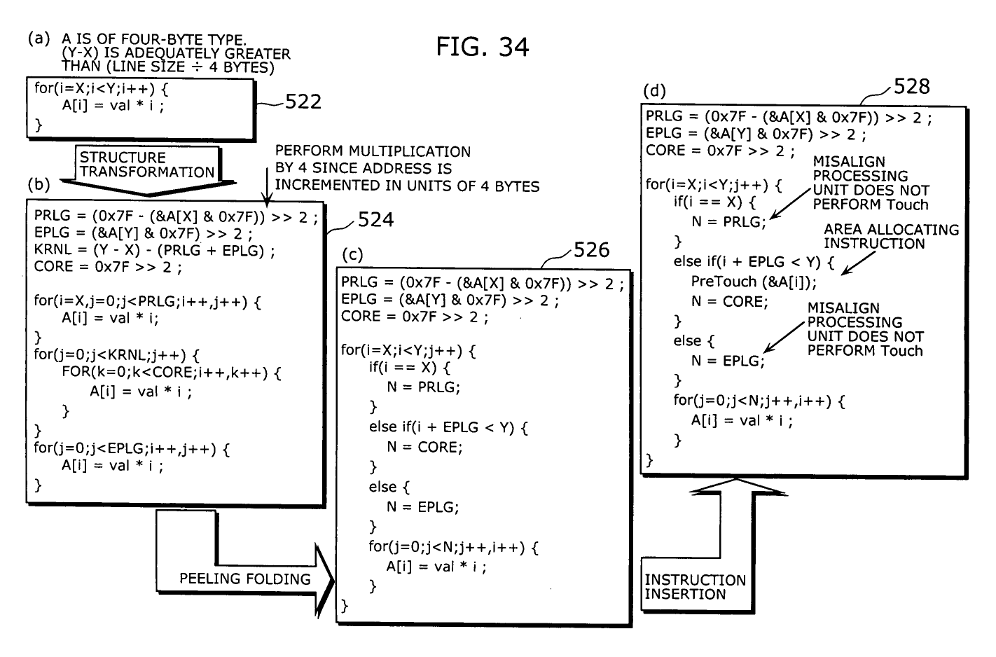

### BRIEF DESCRIPTION OF DRAWINGS

[FIG. 1] FIG. 1 is a diagram explaining about problems of a conventional optimization technique.

[FIG. 2] FIG. 2 is a diagram explaining about a structure transformation for loop processing according to the present invention.

[FIG. 3] FIG. 3 is a diagram showing a construction of a compiler system of an embodiment.

[FIG. 4] FIG. 4 is a diagram showing a construction of a compiler.

[FIG. 5] FIG. 5 is a flowchart showing processing executed by the compiler.

[FIG. 6] FIG. 6 is a diagram explaining about details of loop structure transforming processing.

[FIG. 7] FIG. 7 is a flowchart showing details of copy-type inner loop splitting processing.

[FIG. 8] FIG. 8 is a flowchart showing details of condition-type inner loop splitting processing.

[FIG. 9] FIG. 9 is a flowchart showing details of prefetch instruction placing processing.

[FIG. 10] FIG. 10 is a flowchart showing details of prefetch instruction inserting processing.

[FIG. 11] FIG. 11 is a diagram explaining about simple loop splitting processing of a case where peeling is unnecessary.

[FIG. 12] FIG. 12 is a diagram showing an example of a source program of a case where peeling is unnecessary.

[FIG. 13] FIG. 13 is a diagram showing a program in an intermediate language corresponding to the source program shown in FIG. 12.

[FIG. 14] FIG. 14 is a diagram showing a program in an intermediate language that is obtained after the program in the intermediate language shown in FIG. 13 is structurally transformed into a double loop.

[FIG. 15] FIG. 15 is a diagram showing a program in an intermediate language that is obtained after a prefetch instruction is inserted into the program in the intermediate language shown in FIG. 14.

[FIG. 16] FIG. 16 is a diagram explaining about the simple loop splitting processing of a case where peeling is necessary.

[FIG. 17] FIG. 17 is a diagram explaining about the loop splitting processing of a case where a plurality of array accesses are present in the loop.

[FIG. 18] FIG. 18 is a diagram explaining about the loop splitting processing of a case where a plurality of array accesses are present in the loop.

[FIG. 19] FIG. 19 is a diagram explaining about the loop splitting processing of a case where a plurality of array accesses are present in the loop and each size of elements in the array is different.

[FIG. 20] FIG. 20 is a diagram explaining about the loop splitting processing of a case where a plurality of array accesses are present in the loop and each size of elements in the array is different.

[FIG. 21] FIG. 21 is a diagram explaining about the loop splitting processing of a case where a plurality of array accesses with different strides are present in the loop.

[FIG. 22] FIG. 22 is a diagram explaining about the loop splitting processing for the loop processing in which the loop count is non-fixed.

[FIG. 23] FIG. 23 is another diagram explaining about the loop splitting processing for the loop processing in which the loop count is non-fixed.

[FIG. 24] FIG. 24 is a diagram explaining about optimizing processing of a case where loop splitting is unnecessary.

[FIG. 25] FIG. 25 is a diagram explaining about the loop splitting processing of a case where elements to be accessed within the loop are not appropriately aligned in the main memory.

[FIG. 26] FIG. 26 is a diagram explaining about the loop splitting processing of a case where elements to be accessed in the loop are not appropriately aligned in the main memory.

[FIG. 27] FIG. 27 is a diagram explaining about processing where misaligned array elements are dynamically specified to optimize the loop processing.

[FIG. 28] FIG. 28 is a diagram explaining about misaligned array elements. [FIG. 29] FIG. 29 is a diagram explaining about processing where misaligned array elements are specified using profile information to optimize the loop processing.

[FIG. 30] FIG. 30 is a diagram explaining about loop structure transformation performed on the loop aside from the innermost loop.

[FIG. 31] FIG. 31 is a diagram explaining about optimizing processing of a case where a variable is designated by the pragma “#pragma _loop_tiling_dpref variable name [, variable name]”.

[FIG. 32] FIG. 32 is a diagram explaining about the simple loop splitting processing performed when a PreTouch instruction is inserted in a case where peeling is unnecessary.

[FIG. 33] FIG. 33 is a diagram explaining about the simple loop splitting processing performed when a PreTouch instruction is inserted in a case where peeling is necessary.

[FIG. 34] FIG. 34 is a diagram explaining about processing where misaligned array elements are dynamically specified to optimize the loop processing.

### NUMERICAL REFERENCES

141 source program
142 cache parameter
143 assembler file
144 object file
145 execution program
146 execution log data
147 profile data
148 compiler system
149 compiler
150 assembler
151 linker
152 simulator
153 profiler
181 optimization auxiliary information
182 syntax analyzing unit
183 optimization information analyzing unit
184 general optimizing unit
185 instruction scheduling unit
186 loop structure transforming unit
187 instruction optimum placing unit
188 code outputting unit

### BEST MODE FOR CARRYING OUT THE INVENTION

[System Construction]

FIG. 3 is a diagram showing a construction of a compiler system of the present embodiment. A compiler system 148 is a software system which converts a source program 141 described in a high-level language such as C language into an execution program 145 in machine language. The compiler system 148 includes a compiler 149, an assembler 150, and a linker 151.

The compiler 149 is a program whose target processor is a CPU (Central Processing Unit) of a computer provided with a cache and which converts the source program 141 into an assembler file 143 described in assembler language. When converting the source program 141 into the assembler file 143, the compiler 149 performs optimizing processing based on a cache parameter 142 that is information regarding a cache line size, a latency cycle, etc. and on profile data 147 described later, and then outputs the assembler file 143.

The assembler 150 is a program that converts the assembler file 143 described in assembler language into an object file 144 described in machine language. The linker 151 is a program which links a plurality of object files 144 to generate the execution program 145.

As development tools for the execution program 145, a simulator 152 and a profiler 153 are prepared. The simulator 152 is a program which simulates the execution program 145 and outputs various sets of execution log data 146 obtained during the execution. The profiler 153 is a program which analyzes the execution log data 146 and outputs the profile data 147 obtained by analyzing an execution sequence of the program.

[Construction of Compiler]

FIG. 4 is a diagram showing a construction of a compiler. The compiler 149 includes a syntax analyzing unit 182, an optimization information analyzing unit 183, a general optimizing unit 184, an instruction scheduling unit 185, a loop structure transforming unit 186, an instruction optimum placing unit 187, and a code outputting unit 188. Each processing unit in the configuration is realized as a program.

The syntax analyzing unit 182 is a processing unit which receives the source program 141 as input and outputs a program in an intermediate language after performing the syntax analysis processing.

The optimization information analyzing unit 183 is a processing unit which reads and analyzes information required to perform the optimizing processing on intermediate languages of the cache parameter 142, the profile data 147, a compile option, and a pragma. The general optimizing unit 184 is a processing unit which performs general optimizing processing on intermediate code. The instruction scheduling unit 185 is a processing unit which performs instruction scheduling by optimizing a sequence of instructions. Both the compile option and the pragma are directives to the compiler.

The loop structure transforming unit 186 is a processing unit which transforms a single loop into a double loop. The instruction optimum placing unit 187 is a processing unit which places prefetch instructions in the transformed double loop. The code outputting unit 188 is processing unit which converts a program in the optimized intermediate language into a program described in assembler language and outputs the assembler file 143.

[Processing Flow]

Next, a flow of the processing executed by the compiler 149 is explained. FIG. 5 is a flowchart showing the processing executed by the compiler 149.

The syntax analyzing unit 182 performs syntax analysis on the source program 141 and generates intermediate code (S1). The optimization information analyzing unit 183 analyzes the cache parameter 142, the profile data 147, the compile option, and the pragma (S2). The general optimizing unit 184 performs the general optimization for the intermediate code in accordance with the analysis result given by the optimization information analyzing unit 183 (S3). The instruction scheduling unit 185 performs the instruction scheduling (S4). The loop structure transforming unit 186 focuses on the loop structure included in the intermediate code and transforms a single loop structure into a double loop structure if necessary (S5). The instruction optimum placing unit 187 inserts an instruction into the intermediate code for prefetching data to be referenced within the loop structure (S6). The code outputting unit 188 converts the intermediate code into assembler code, and outputs it as the assembler file 143 (S7).

Each processing of the syntax analyzing processing (S1), the optimization information analyzing processing (S2), the general optimizing processing (S3), the instruction scheduling processing (S4), and the assembler code outputting processing (S7) is the same as corresponding common processing. Thus, detailed explanations about them are omitted here.

The following are detailed explanations about the loop structure transforming processing (S5) and the prefetch instruction placing processing (S6).

FIG. 6 is a diagram explaining about the details of the loop structure transforming processing (S6 in FIG. 5). The loop structure transforming unit 186 judges whether or not the loop count is given as an immediate value and so can be derived or the loop count is given as other types of value such as a variable and so cannot be derived (S11). To be more specific, whether the loop count is fixed or non-fixed is judged.

When the loop count is non-fixed (NO in S11), a judgment is made by the pragma or the compile option as to whether the minimum loop count is designated, or as to whether it is designated to dynamically judge the loop count and split the loop during the program execution (S12).

When either directive is present (YES in S12) or the loop count is a fixed value (YES in S11), a judgment is made as to whether or not a subscript of an array referenced within the loop is analyzable (S13). To be more specific, when the value of the loop counter varies with certain regularity, the subscript is judged to be analyzable. For example, when the value of the loop counter is to be rewritten within the iteration, it is judged not to be analyzable.

When the subscript is analyzable (YES in S13), the numbers of bytes of elements to be referenced in one iteration is obtained for each array referenced during the loop processing and a minimum value LB among the obtained numbers is derived (S14).

Next, a judgment is made as to whether or not a value derived by dividing the cache line size CS by the value LB is greater than one (S15). When the value of CS/LB is greater than one (YES in S15), a judgment is made as to whether or not the arrays of the loop processing are aligned (S16). Whether or not the arrays are aligned is judged by whether it is designated by the pragma or the compile option that the arrays are aligned.

When the arrays are not aligned (NO in S17), a judgment is made as to whether or not “LB*LC/IC” is greater than CS (S16). Here, LC represents the number of latency cycles, and IC represents the number of cycles per iteration. Also, “LC/IC” represents the loop count for each loop when the loop is split into a plurality of innermost loops, and “LB*LC/IC” represents the access capacity of the loop.

When “LB*LC/IC” is greater than the line size CS (YES in S16), the elements corresponding to a size of one line or more are referenced in each loop processing after the splitting. As such, the cycle is considered as a split factor, and a loop count DT of the innermost loop is derived according to the following expression (1) for a case where each loop processing is transformed into a double loop (S18).
DT=(LC−1)/IC+1 (1)

When “LB*LC/IC” is smaller than the line size CS (NO in S16) or the arrays are aligned (YES in S17), the size is considered as a split factor and the loop count DT of the innermost loop is derived according to the following expression (2) for a case where each loop processing is transformed into a double loop (S19).
DT=(CS−1)/LB+1 (2)

After the processing of deriving the loop count DT of the innermost loop (S18 or S19), a judgment is made as to whether or not the loop count DT of the innermost loop is greater than one (S20). When DT is one (NO in S20), the loop does not need to be structurally transformed into a double loop since the loop count DT of the innermost loop is one. Thus, the loop structure transforming processing (S5) is terminated.

When the loop count DT of the innermost loop is two or more (YES in S20), an outer loop structure is generated for a case where the loop is transformed into a double loop (S21). When generating the outer loop structure, a judgment is made as to whether or not the peeling processing is necessary (S22). A method of judging whether or not the peeling processing is necessary is described later on.

When the peeling processing is necessary (NO in S22), the peeling processing is performed and peeling code is generated (S24). Following this, a judgment is made as to whether or not a directive by the compile option “—O” or “—Os” is present (S25). Here, the compile option “—O” is a directive for having the compiler output the assembler code that has the average program size and execution processing speed. The compile option “—Os” is a directive for having the compiler output the assembler code with a high regard for a reduction in the program size.

When the peeling processing is unnecessary (YES in S22) or there is no directive by the compile option “—O” or “—Os” (NO in S25), a conditional expression is generated for the loop count of the inner loop (innermost loop) (S23).

When the directive by the compile option “—O” or “—Os” is present (YES in S25), the loop processing peeled off is folded into a double loop and a conditional expression is generated for the loop count of the innermost loop (S26).

After the processing of generating the loop count condition of the innermost loop (S23 or S26), a judgment is made as to whether or not the number of target arrays to be referenced within the innermost loop is one (S27). When the number of target arrays to be referenced within the innermost loop is one (YES in S27), the loop structure transforming processing (S5) is terminated.

When the number of target arrays to be referenced within the innermost loop is two or more (NO in S27), the number of splits of the innermost loop is derived and a ratio of the loop counts of the innermost loops after the splitting is determined (S28). Following this, a judgment is made as to whether or not a value obtained by dividing the innermost loop count DT after the splitting by the number of splits is greater than one (S29). To be more specific, when the present value is one or less (NO in S29), there is no point in splitting since each loop count after the splitting is one or less (NO in S29). Thus, the loop structure transforming processing (S5) is terminated.

When the present value is greater than one (YES in S29), this means that each loop count after the splitting is two or more. In this case, a judgment is made as to whether or not there is directive by the compile option “—O” or “—Ot” (S30). The compile option “—Ot” is a directive for having the compiler output the assembler code with a high regard for an improvement in the execution processing speed.

When the directive by the compile option “—O” or “—Os” is present (YES in S30), copy-type inner loop splitting processing, which is described later, is executed with a high regard for an improvement in the execution processing speed (S31). Then, the loop structure transforming processing (S5) is terminated.

When the directive by the compile option “—O” or “—Os” is not present (NO in S30), condition-type inner loop splitting processing, which is described later, is executed with a high regard for a reduction in the program size (S32). Then, the loop structure transforming processing (S5) is terminated.

FIG. 7 is a flowchart showing details of the copy-type inner loop splitting processing (S31 in FIG. 6).

A value obtained by dividing the loop count DT of the innermost loop by the number of splits is referred to as a post-subdividing inner loop count (S41). Next, the inner loop is copied the number of times corresponding to the number of splits so as to generate the inner loops (S42). Following this, each inner loop count after the subdividing is modified to the post-subdividing inner loop count (S43). Moreover, a remainder left over after DT was divided by the number of splits is added to the loop count of the post-subdividing head loop (S44), and the copy-type inner loop splitting processing is terminated.

FIG. 8 is a flowchart showing details of the condition-type inner loop splitting processing (S32 in FIG. 6).

A value obtained by dividing the loop count DT of the innermost loop by the number of splits is referred to as a post-subdividing inner loop count (S51). Next, an inner loop count condition switch table is generated (S52). To be more specific, a switch statement, which is so called in C language, is generated so that the inner loop count will be sequentially switched. It should be noted that the statement may be an if statement.

After the generation of the table, each inner loop count condition after the subdividing is modified to the post-subdividing inner loop count (S53). Following this, a remainder left over after DT was divided by the number of splits is added to the loop count condition of the post-subdividing head loop (S54), and the condition-type inner loop splitting processing is terminated.

FIG. 9 is a flowchart showing details of the prefetch instruction placing processing (S6 in FIG. 5).

In the prefetch instruction placing processing, the following processing is repeated for all the loops (loop A). First, the loop in question is checked whether it is a target loop for instruction insertion (S61). Information as to whether it is the target loop for instruction insertion is obtained from the analysis result given by the loop structure transforming unit 186.

In the case of the target loop for instruction insertion (YES in S61), a judgment is made as to whether the condition-type loop splitting has been performed on the loop in question (S62). When the condition-type loop splitting has been performed, a position of the instruction insertion is analyzed for each conditional statement (S63) then a prefetch instruction is inserted (S64). When the condition-type loop splitting has not been performed on the target loop for the instruction insertion (NO in S62), a judgment is made as to whether the copy-type loop splitting has been performed on the present loop (S65). When the copy-type loop splitting has been performed (YES in S65), the position of the instruction insertion before the present loop is analyzed (S66). After this, the prefetch instruction is inserted (S67). In the case of the peeled loop (YES in S68), the position of the instruction insertion is analyzed so that the instruction will be inserted before the present loop (S69) and the prefetch instruction is inserted into that position (S70).

FIG. 10 is a flowchart showing details of the prefetch instruction inserting processing (S64, S67, and S70 in FIG. 9).

In the instruction inserting processing, the following is repeated until the time comes when an information list composed of an insertion instruction, an insertion position, and an insertion address will become empty (loop B).

A judgment is made as to whether or not the array elements among which the prefetch instruction is to be inserted have been aligned (S72). When they have not been aligned (NO in S72), a judgment is made as to whether the loop splitting was performed in accordance with the cycle factor or the loop splitting was performed in accordance with the size factor (S73).

When they have been aligned (YES in S72) or the loop splitting has been performed in accordance with the cycle factor (YES in S73), an instruction for prefetching data one line ahead is inserted (S74). When they have not been aligned and the loop splitting has been performed in accordance with the size factor (NO in S73), an instruction for prefetching data two lines ahead is inserted (S75). Finally, the analyzed information is deleted from the information list (S76).

[Compile Option]

In the compiler system 148, an option “-fno-loop-tiling-dpref” is prepared as a compile option for the compiler. When this option is designated, the structure transformation will not be performed on the loop regardless of directive by the pragma. When the present option is not designated, whether or not to execute the structure transformation is determined in accordance with the presence or absence of directive by the pragma.

[Directive by Pragma]

The present directive is used for the immediate subsequent loop.

When a variable is designated by the pragma “#pragma _loop_tiling_dpref variable name [, variable name]”, the loop splitting is performed with attention being paid only to the variable designated by the pragma. The variable to be designated may be an array or a pointer.

When a loop is designated by the pragma “#pragma _loop_tiling_dpref_all”, the structure transformation is performed with attention being paid all the arrays to be referenced within the loop.

The following is an explanation about the loop splitting processing in some specific phases. It should be noted that although in the following processing the program is described in C language for the sake of simplicity, the actual optimizing processing is performed in the intermediate language.

[Simple Loop Splitting]

FIG. 11 is a diagram explaining about the simple loop splitting processing of a case where peeling is unnecessary.

Consideration is given to a case where a source program 282 shown in FIG. 11(a) is inputted. In the source program 282, elements of the array A are sequentially referenced and added to a variable sum. Note here that the size of each element of the array A is four bytes and the cache line size is 128 bytes (the cache line size will also be 128 bytes in the following description). More specifically, 32 elements of the array A are stored in one line of the cache. Also, the iteration count of the loop included in the source program 282 is 128, which is an integral multiple of 32. Therefore, as shown by a program 284 in FIG. 11(b), the source program 282 can be structurally transformed into a double loop. To be more specific, iteration processing is repeated 32 times within the innermost loop and the innermost loop is iterated four times in an outer loop. In the innermost loop processing, one cache line of data is referenced. After this, as shown by a program 286 in FIG. 11(c), a prefetch instruction (dpref (&A[i+32])) is inserted prior to the execution of the innermost loop. By the insertion of the prefetch instruction, the elements of the array A to be referenced within the innermost loop will be in the cache when the present loop is executed.

FIGS. 12 to 15 are diagrams explaining about the progression of the intermediate language in the simple loop splitting processing in which peeling is unnecessary.

As with FIG. 11(a), FIG. 12 is a diagram showing an example of a source program of a case where peeling is unnecessary. FIG. 13 is a diagram showing a program in an intermediate language corresponding to the source program 240 shown in FIG. 12. Instruction strings described between [BGNBBLK] and [ENDBBLK] correspond to a basic block. A basic block beginning with [BGNBBLK]B1 shows processing that is performed immediately before a for loop. A basic block beginning with [BGNBBLK]B2 shows the for loop. A basic block beginning with [BGNBBLK]B3 shows processing that is performed after the for loop.

FIG. 14 is a diagram showing a program in an intermediate language that is obtained after the program in the intermediate language shown in FIG. 13 is structurally transformed into a double loop. The basic block beginning with [BGNBBLK]B2 corresponds to the innermost loop, and the loops beginning with [BGNBBLK]B4 and [BGNBBLK]B5 correspond to the outer loops.

FIG. 15 is a diagram showing a program in an intermediate language that is obtained after the prefetch instruction is inserted into the program in the intermediate language shown in FIG. 14. In the program 270, a prefetch instruction (dpref) is newly inserted in the basic block beginning with [BGNBBLK]B4.

FIG. 16 is a diagram explaining about the simple loop splitting processing of a case where peeling is necessary.

Consideration is given to a case where a source program 292 shown in FIG. 16(a) is inputted. In the source program 292, elements of the array A are sequentially referenced and added to a variable sum. Note here that the size of each element of the array A is four bytes. More specifically, 32 elements of the array A are stored in one line of the cache. Also note that the iteration count of the loop included in the source program 292 is 140. As such, when the iteration count is divided by 32 which is the number of elements of the array A to be stored in one line, there will be a remainder left over.

In such a case, as shown by a program 294 in FIG. 16(b), the loop count left over as a remainder after 140 was divided by 32 is peeled off and the loop except for the remainder is structurally transformed into a double loop as is the case shown in FIG. 11(b). After this, peeling folding processing is performed so that the peeled part is included into the double-loop structure. As a result, a program 296 as shown in FIG. 16(c) is obtained. To be more specific, the iteration processing is performed 32 times within the innermost loop in normal times while the iteration processing is performed 12 (=140−128) remaining times when the innermost loop is executed lastly. After this, as shown by a program 298 in FIG. 16(d), a prefetch instruction (dpref(&A[i+32])) is inserted prior to the execution of the innermost loop.

[Case Where a Plurality of Array Accesses are Present (Peeling is Unnecessary)]

FIG. 17 is a diagram explaining about the loop splitting processing of a case where a plurality of array accesses are present in the loop.

Consideration is given to a case where a source program 301 shown in FIG. 17(a) is inputted. In the source program 301, elements of the arrays A and B are sequentially referenced and a product derived by a multiplication of the elements of the respective arrays is added to a variable sum. Note here that the size of each element of the arrays A and B is four bytes. More specifically, 32 elements of the array A are stored in one line of the cache, and 32 elements of the array B are also stored in one line of the cache. This means that the respective numbers of elements of the arrays A and B to be stored in one line are the same. Also note that the iteration count of the loop included in the source program 301 is 128, which is an integral multiple of 32. Therefore, as shown by a program 302 in FIG. 17(b), the source program 301 can be structurally transformed into a double loop.

For the double-loop structure where a plurality of array accesses are present, there are two kinds of optimizations which are: optimization called copy-type for improving the execution processing speed; and optimization called condition-type for reducing the program size.

First, the copy-type optimization is explained. The loop count of the innermost loop included in the program 302 is split according to a size ratio between the elements of the arrays A and B. Here, the sizes of the elements of the arrays A and B are the same. Thus, as shown by a program 303 in FIG. 17(c), the innermost loop is split in halves to obtain two innermost loops, each loop count being 16. Following this, as shown by a program 304 in FIG. 17(d), a prefetch instruction is inserted immediately before each innermost loop. A prefetch instruction (dpref(&A[i+32])) for prefetching one line of the elements of the array A is inserted immediately before the first innermost loop. A prefetch instruction (dpref(&B[i+32])) for prefetching one line of the elements of the array B is inserted immediately before the second innermost loop.

By inserting the loop processing between the prefetch instructions in this way, the prefetch instructions for different arrays will not be issued in a row. As such, a latency caused by the execution of the prefetch instruction can be hidden. Consequently, the execution processing speed can be improved.

Next, the condition-type optimization is explained. As is the case with the copy-type optimization, the loop count of the innermost loop is split according to a size ratio between the elements of the arrays A and B in the condition-type optimization. However, the two innermost loops are not arranged in the manner shown in the program 303. As shown by a program 305 in FIG. 17(e), the number of innermost loops is one and its loop count is to take a conditional branch. To be more specific, the loop count N of the innermost loop is varied depending on the case where a variable K is one or zero. Note, however, that the loop count N of the innermost loop is 16 regardless of the value of the variable K in the present example. Next, as shown by a program 306 in FIG. 17(f), conditional branch expressions and prefetch instructions are inserted so that the elements of one line of the array A are prefetched when K=1 and the elements of one line of the array B are prefetched when K=0. Note here that the loop count N is replaced with an immediate value 16 by optimization.

By setting the number of innermost loops at one and varying the loop count and the prefetch instructions of the innermost loop using the conditional branch expressions, the program size of machine language instructions that are eventually generated can be reduced. However, due to the conditional branch processing, there is a possibility that the processing speed may be slightly slower as compared with the case of the copy-type optimization.

[Case Where a Plurality of Array Accesses are Present (Peeling is Necessary)]

FIG. 18 is a diagram explaining about the loop splitting processing of a case where a plurality of array accesses are present in the loop.

Consideration is given to a case where a source program 311 shown in FIG. 18(a) is inputted. In the source program 311, elements of the arrays A and B are sequentially referenced and a product derived by a multiplication of the elements of the respective arrays is added to a variable sum. Note here that the size of each element of the arrays A and B is four bytes. More specifically, 32 elements of the array A are stored in one line of the cache, and 32 elements of the array B are also stored in one line of the cache. This means that the respective numbers of elements of the arrays A and B to be stored in one line are the same. Also note that the iteration count of the loop included in the source program 311 is 140.

Accordingly, when structurally transforming the source program 311 into a double-loop structure, a program 312 shown in FIG. 18(b) is generated after the peeling processing is performed as with the program 294 shown in FIG. 16(b).

When the copy-type optimization is performed, the innermost loop is split according to a size ratio between the elements of the arrays A and B. As a result, a program 313 shown in FIG. 18(c) is generated. Following this, as shown by a program 314 in FIG. 18(d), a prefetch instruction (dpref(&A[i+32])) for prefetching one line of the elements of the array A is inserted immediately before the first innermost loop, and a prefetch instruction (dpref(&B[i+32])) for prefetching one line of the elements of the array B is inserted immediately before the second innermost loop. Note that a prefetch instruction is not inserted immediately before the final loop on which the peeling processing has been performed. This is because desired data was prefetched into the cache through the executions of the prefetch instructions in the previous double-loop processing.

When the condition-type optimization is performed, the peeling folding processing is performed on the program 312. As a result, a program 315 shown in FIG. 18(e) is obtained. The peeling folding processing is the same as the one explained with reference to FIG. 16. Next, the loop count of the innermost loop is split according to a size ratio between the elements of the arrays A and B, and a program 316 as shown in FIG. 18(f) is generated so that the present loop count takes a conditional branch. In the program 316, by alternately varying the value of the variable K, the value of the loop counter N is varied corresponding to the value of the variable K. Next, as shown by a program 317 in FIG. 18(g), prefetch instructions are inserted in the conditional branch expressions so that the elements of one line of the arrays A and B are alternately prefetched in accordance with the change in the value of the variable K.

In this way, when peeling is necessary, the peeled part is made as a loop separate from the a double loop in the case of the copy type whereas the value of the loop counter after the peeling processing is varied according to the conditional branch expression in the case of the condition type. Accordingly, when a plurality of array accesses are present in the loop and peeling is necessary, optimization can be performed in consideration of the latency caused by the prefetching.

[Case Where a Plurality of Array Accesses with Different Sizes are Present (Peeling is Unnecessary)]

FIG. 19 is a diagram explaining about the loop splitting processing of a case where a plurality of array accesses are present in the loop and each size of elements in the array is different.

Consideration is given to a case where a source program 321 shown in FIG. 19(a) is inputted. Here, note that the size of each element of the array A is four bytes and the size of each element of the array B is two bytes. More specifically, 32 elements of the array A are stored in one line of the cache whereas 64 elements of the array B are stored in one line of the cache.

In this case, attention is paid to the array B which has smaller element size and the loop structure transformation is performed corresponding to the elements of the array B. To be more specific, as shown by a program 322 in FIG. 19(b), the loop count of the innermost loop is set at 64 which is the number of elements of the cache B that fit within one line, and the loop is structurally transformed into a double loop. In the innermost loop, one line of elements of the array B are consumed while two lines of elements of the array A are consumed. On this account, three lines of data is required to execute the innermost loop processing.

Thus, when the copy-type optimization is performed, the innermost loop is split into three as shown by a program 323 in FIG. 19(c) and prefetch instructions are respectively inserted immediately before the innermost loops as shown by a program 324 in FIG. 19(d). In the present case, a prefetch instruction (dpref(&A[i+64])) for prefetching the elements of the array A two lines ahead is inserted immediately before the first innermost loop. A prefetch instruction (dpref(&A[i+96])) for prefetching the elements of the array A three lines ahead is inserted immediately before the second innermost loop. A prefetch instruction (dpref(&B[i+64])) for prefetching the elements of the array B one line ahead is inserted immediately before the third innermost loop. Note that the respective loop counts of the three innermost loops are 22, 21, and 21 in the processing order. This is because the conditional branch judgment for the outermost loop is made after the execution of the third innermost loop and the reduction in the loop count of the third innermost loop allows the overall processing speed to be improved.

When the condition-type optimization is performed, the variable K is updated within a range of values from zero to two during one set of the innermost loop processing and the loop count N of the innermost loop is set at one of 22, 21, and 21 through the conditional branch processing in accordance with the value of the variable K, as shown by a program 325 in FIG. 19(e). After this, the innermost loop with the loop count N is executed. Next, as shown by a program 326 in FIG. 19(f), the optimization is performed so that: the prefetch instruction (dpref(&A[i+64])) is executed when the value of the variable K is zero; the prefetch instruction (dpref(&A[i+96])) is executed when the value of the variable K is one; and the prefetch instruction (dpref(&B[i+64])) is executed when the value of the variable K is two.

[Case Where a Plurality of Array Accesses with Different Sizes are Present (Peeling is Necessary)]

FIG. 20 is a diagram explaining about the loop splitting processing of a case where a plurality of array accesses are present in the loop and each size of the elements in the array is different.

A source program 331 shown in FIG. 20(a) is the same as the source program 321 shown in FIG. 19(a) except for the loop count. Therefore, as is the case with the source program 321, the element size of the array A is four bytes and the element size of the array B is two bytes. As shown in FIG. 20(b), the loop of the source program 321 is structurally transformed into a double loop, and the peeling processing is performed on a remainder left over after the loop count 140 was divided by 64 which is the number of elements of the array B stored in one line. As a result, a program 322 is obtained. When the copy-type optimizing processing is performed, as explained with reference to FIGS. 19(c) and (d), the innermost loop of the double loop is divided into three and the prefetch instructions are inserted. Accordingly, a program 333 shown in FIG. 20(c) is obtained. When the condition-type optimizing processing is performed, as explained with reference to FIGS. 19(e) and (f), the loop count and prefetch instructions are controlled according to the conditional branch expressions. As a result, a program 335 shown in FIG. 20(e) is eventually obtained.

[Case Where a Plurality of Array Accesses with Different Strides are Present]

FIG. 21 is a diagram explaining about the loop splitting processing of a case where a plurality of array accesses with different strides are present in the loop.

A stride refers to a value of an increment (an access width) of array elements in the loop processing. Consideration is given to a case where a source program 341 shown in FIG. 21(a) is inputted. Here, the size of each element of the arrays A and B is four bytes. In the source program 341, the number of elements of the array A is incremented by one whereas the number of elements of the array B is incremented by two for each iteration of the loop. In other words, the access width of the array B is twice as wide as the access width of the array A. As to the array A having the minimum access width, 32 elements of the array A are fitted in one line. As such, when the loop is structurally transformed into a double loop where the loop count of the innermost loop is 32, a program 342 shown in FIG. 21(b) is obtained. Within the innermost loop, one line of elements of the array A are consumed while two lines of elements of the array B are consumed. Therefore, three lines of data is required for the execution of the innermost loop processing.

Accordingly, when the copy-type optimization is performed, the innermost loop is divided into three as shown by a program 343 in FIG. 21(c) and prefetch instructions are respectively inserted immediately before the innermost loops as shown by a program 344 in FIG. 21(d). In the present case, a prefetch instruction (dpref(&A[i+32])) for prefetching the elements of the array A one line ahead is inserted immediately before the first innermost loop. A prefetch instruction (dpref(&B[i*2+64])) for prefetching the elements of the array B two lines ahead is inserted immediately before the second innermost loop. A prefetch instruction (dpref(&B[i*2+96])) for prefetching the elements of the array B three lines ahead is inserted immediately before the third innermost loop.

On the other hand, when the condition-type optimization is performed, the variable K is updated within a range of values from zero to two during one set of the innermost loop processing and the loop count N of the innermost loop is set at one of 11, 11 and 10 through the conditional branch processing in accordance with the value of the variable K, as shown by a program 345 in FIG. 21(e). After this, the innermost loop with the loop count N is executed. Next, as shown by a program 346 in FIG. 21(f), the optimization is performed so that: the prefetch instruction (dpref(&A[i+32])) is executed when the value of the variable K is zero; the prefetch instruction (dpref(&B[i*2+64])) is executed when the value of the variable K is one; and the prefetch instruction (dpref(&B[i*2+96])) is executed when the value of the variable K is two.

[Case Where the Loop Count is Non-Fixed]

FIG. 22 is a diagram explaining about the loop splitting processing for the loop processing in which the loop count is non-fixed.

Consideration is given to a case where a source program 351 shown in FIG. 22(a) is inputted. The loop count included in the source program 351 is specified by a variable Val and is non-fixed when compilation is performed. However, it is assured by a pragma directive “#pragma _min_iteration=128” that the iteration processing is performed 128 times at the minimum. Here, note that the size of an element of the array A is four bytes. In other words, 32 elements of the array A are stored in one line of the cache.

In accordance with the pragma directive, the loop processing is split into the former loop processing that is performed 128 times and the latter loop processing that is performed the number of times corresponding to the loop count specified by the variable Val. As is the case with the simple loop, each processing is transformed into a double loop, so that a program 352 shown in FIG. 22(b) is obtained.

When the copy-type optimization is performed, a prefetch instruction (dpref(&A[i+32])) for prefetching the elements of the array A one line ahead is inserted immediately before the innermost loop of the program 325. As a result, a program 353 shown in FIG. 22(c) is obtained.

When the condition-type optimization is performed, the peeling folding processing is performed on the latter loop processing. Then, a branch instruction is inserted so that the innermost loop count is set at 32 until the outermost loop count reaches 128 and that the innermost loop count afterward is set at a count derived from (Val-128). As a result, a program 354 shown in FIG. 22(d) is obtained.

Finally, a prefetch instruction (dpref(&A[i+32])) is inserted prior to the execution of the innermost loop. As a result, a program 355 shown in FIG. 22(e) is obtained.

FIG. 23 is another diagram explaining about the loop splitting processing for the loop processing in which the loop count is non-fixed.

Consideration is given to a case where a source program 361 shown in FIG. 23(a) is inputted. The loop count included in the source program 361 is specified by a variable N and is non-fixed when compilation is performed. Unlike the source program 351, the source program 361 does not have a pragma directive that shows the minimum loop count.

Even if the optimization is executed through the loop structure transformation performed on the loop processing whose loop count is small, the effect of the optimization would be less likely to show. For this reason, in order to heighten the effect of the optimization, the optimized loop is to be executed when the loop count is greater than a certain threshold value in such a case whereas the normal loop processing is to be executed in other cases. For example, suppose that the threshold value is 1024. As shown by a program 362 in FIG. 23(b), when the loop count N exceeds 1024, the double loop is executed for the former loop processing that is performed 1024 times whereas the loop processing on which the peeling processing has been performed is executed for the rest of the count. When the loop count N is 1024 or less, the double loop is not executed but the loop processing on which the peeling processing has been performed is executed. After this, a prefetch instruction (dpref(&A[i+32])) is inserted immediately before the innermost loop of the double loop. As a result, a program 363 shown in FIG. 23(c) is obtained.

[Case Where Loop Splitting is Unnecessary]

FIG. 24 is a diagram explaining about the optimizing processing of a case where loop splitting is unnecessary. When a source program 371 shown in FIG. 24(a) is inputted, one line of data (A[i] to A[i+31]) is completely consumed within the loop. In such a case, the double looping is unnecessary. On account of this, optimization is achieved by inserting a prefetch instruction (dpref(&A[i+32])) at the head of the loop for prefetching data one line ahead of data which is to be used within the loop, as shown by a program 372 in FIG. 24(b).

Moreover, even when the number of processing cycles in the loop is greater than the number of processing cycles required to execute the prefetch instruction, the double looping is unnecessary. Even though the prefetch instruction is inserted at the head of the loop, the latency caused by the prefetch instruction can be hidden.

[Case Where the Elements to be Accessed are Misaligned]

FIGS. 25 and 26 are diagrams explaining about the loop splitting processing of a case where the elements to be accessed in the loop are not appropriately aligned in the main memory. The above explanation has been given on the assumption that the elements to be accessed in the loop would be appropriately aligned in the main memory. When it is known in advance from the directive of the pragma or compile option that the elements are aligned, the optimization explained in the above examples is performed.

However, in general, the compiler has no way to know whether the elements are aligned or not before the execution. On account of this, the compiler needs to perform the optimization on the precondition that the elements to be accessed in the loop are not appropriately aligned in the main memory.

To be more specific, when a source program 381 shown in FIG. 25(a) is given and the size of an element of the array A is four bytes, the optimization is performed as is the case with the simple loop splitting explained with reference to FIG. 11. However, since the precondition is that the elements are not aligned, a prefetch instruction (dpref(&A[i+64])) to be inserted before the innermost loop designates to prefetch the elements of the array A two lines ahead. Prior to the loop processing, in order to allocate the elements A[0] to A[63] of the array to be accessed in the loop, prefetch instructions (dpref(&A[0]) and dpref(&A[32])) are inserted into such positions that the latency caused by the prefetches can be adequately hidden. As a result, a program 382 shown in FIG. 25(b) is obtained.

When a source program 391 shown in FIG. 26(a) is given, the processing is the same as the case shown in FIG. 16. After the folding processing is performed on the peeled part, a prefetch instruction (dpref(&A[i+64])) for prefetching the elements of the array A two lines ahead is inserted. Moreover, as is the case with the program 382, the prefetch instructions (dpref(&A[0]) and dpref(&A[32])) are inserted. As a result, a program 392 shown in FIG. 26(b) is obtained.

[Structure Transformation Splitting by Insertion of Dynamic Alignment Analyzing Code]

FIG. 27 is a diagram explaining about processing where misaligned array elements are dynamically specified to optimize the loop processing. Consideration is given to a case where a source program 401 shown in FIG. 27(a) is inputted. Here, note that the size of an element of the array A is four bytes.

Predetermined bits of a head address of the array A (address of an element A[0]) indicate a cache line, and out of these bits, another predetermined bits indicate an offset from the head of the line. Thus, through a logical operation of bits called “A&Mask”, the offset from the head of the line can be derived. Here, the value of Mask is predetermined. By shifting the offset value derived from the head address of the array A to the right by a predetermined correction value Cor, the position of the head element A[0] of the array A in relation to the head of one line can be determined. Thus, the number of elements n which are not aligned on the line can be derived according to the following expression (3).
n=32−(A&Mask)>>Cor (3)

More specifically, as shown in FIG. 28, a distinction is made between the misaligned elements (A[0] to A[n−1]) of the array A and the aligned elements of the array A, when they are fetched to a cache 431.

Thus, as shown by a program 402 in FIG. 27(b), the number of misaligned elements n of the array A is derived according to the expression (3). Next, the loop processing is performed for the misaligned elements (A[0] to A[n−1]) of the array A in accordance with the number of elements n. After this, for the aligned elements (from the element A[n] onward) of the array A, the transformation into a double loop is performed as in the case of the simple loop splitting explained with reference to FIG. 11.

Then, the folding processing is performed on a peeled loop 405, so that a program 403 shown in FIG. 27(c) is generated. Moreover, by inserting a prefetch instruction (dpref (&A[i+32])), an optimized program 404 as shown in FIG. 27(d) is obtained.

[Structure Transformation Splitting Using Profile Information]

FIG. 29 is a diagram explaining about processing where the misaligned elements are specified using profile information to optimize the loop processing. Unlike the case shown in FIG. 27 where the number of misaligned array elements is obtained through calculation, the number is obtained from profile information in the present case. On the basis of the obtained number of misaligned array elements N, the same processing as shown in FIG. 27 is performed. Then, a source program 411 shown in FIG. 29(a) is converted into a program 412 shown in FIG. 29(b). After this, the folding processing is performed on the peeled part of the loop, so that a program 413 shown in FIG. 29(c) is obtained. Finally, by inserting a prefetch instruction, an optimized program 414 is obtained as shown in FIG. 29(d).

[Structure Transformation Performed on the Loop aside from the Innermost Loop]

FIG. 30 is a diagram explaining about loop structure transformation performed on the loop aside from the innermost loop.

Consideration is given to a case where a source program 421 shown in FIG. 30(a) is inputted. Note that the double looping processing has been performed for the source program 421 and that the size of an element of the array A to be referenced in the innermost loop processing 424 is one byte. Since the loop count of the innermost loop processing 424 is four, four bytes of the elements of array A are referenced in the innermost loop processing 424. As such, the number of bytes of the elements to be referenced in the innermost loop processing 424 is small. In such a case, the innermost loop processing 424 is considered to be one block and the outermost loop is structurally transformed into a double loop as shown by a program 422 in FIG. 30(b). After this, a prefetch instruction (dpref(&A[j+128])) for prefetching one cache line of the elements of the array A is inserted prior to the execution of the second loop processing. As a result, an optimized program 423 shown FIG. 30(c) is obtained.

[Variable Directive by Pragma “#pragma _loop_tiling_dpref variable name [, variable name]”]

FIG. 31 is a diagram explaining about optimizing processing of a case where a variable is designated by the pragma “#pragma _loop_tiling_dpref variable name [, variable name]”. As shown in FIG. 31(a), when a directive by the pragma “#pragma _loop_tiling_dpref b” is included in the source program, the structure transformation is performed with attention being paid only to an array b in the loop and an array a being ignored. Accordingly, the double looping is executed as shown in FIG. 31(b), and only an instruction for prefetching the array b is inserted.

As described so far, according to the compiler system of the present embodiment, the loop processing is transformed into a double loop and the prefetch instruction is executed outside the innermost loop. This can prevent needless prefetch instructions from being issued, thereby improving the processing speed of the program execution. Moreover, the double loop processing ensures the required number of cycles between the executions of one prefetch instruction and a next prefetch instruction. On account of this, the latency can be hidden, and interlocks can be prevented from occurring.

Up to this point, the compile system of the embodiment of the present invention has been explained on the basis of the present embodiment. However, the present invention is not limited to the present embodiment.

For example, an instruction placed by the instruction optimum placing unit 187 is not limited to a prefetch instruction. The instruction may be: an usual memory access instruction; a response wait instruction such as an instruction that waits for a processing result after activating external processing; an instruction that may result in an interlock after executed; or an instruction that requires a plurality of cycles until a predetermined resource becomes referable. The response wait instructions include an instruction that might wait or not wait for a response as the case may be, as well as an instruction that always wait for a response.

Moreover, the system may be a compile system whose target processor is a CPU of a computer having no caches and which outputs such code that hides latencies caused by various kinds of processes and prevents interlocks from occurring.

Furthermore, the system may be realized as an OS (Operating System) which sequentially interprets machine instructions to be executed by the CPU and executes processing such as the loop structure transformation described in the present embodiment.

In addition, the present invention is applicable to instructions that have no possibility of causing interlocks, such as a PreTouch instruction described below. A PreTouch instruction is an instruction for executing processing that only previously allocates an area to store a variable designated by an argument in a cache. The following is an explanation about processing in which the loop structure transformation is performed and a PreTouch instruction is inserted.

[Simple Loop Splitting]

FIG. 32 is a diagram explaining about the simple loop splitting processing performed when a PreTouch instruction is inserted in a case where a target area is aligned to the cache size and peeling is unnecessary.

Consideration is given to a case where a source program 502 shown in FIG. 32(a) is inputted. The source program 502 defines the processing in which an operation result (multiplication result) of a loop count i and a variable val is sequentially assigned to elements of the array A. Note here that the size of each element of the array A is four bytes and the cache line size is 128 bytes (the cache line size will also be 128 bytes in the following description). More specifically, 32 elements of the array A are stored in one line of the cache. Also note that the iteration count of the loop included in the source program 502 is 128, which is an integral multiple of 32.

Thus, as shown by a program 504 in FIG. 32(b), the source program 502 can be structurally transformed into a double loop. To be more specific, iteration processing is repeated 32 times within the innermost loop and the innermost loop is iterated four times outside the present loop. For the innermost loop processing, one cache line of data is assigned to the array A. After this, as shown by a program 506 in FIG. 32(c), a cache area allocating instruction (PreTouch (&A[i])) is inserted prior to the execution of the innermost loop. By the insertion of the PreTouch instruction, the elements of the array A to be defined in the innermost loop will be allocated in the cache area when the present loop is executed. This causes no unnecessary data transfers from the main memory, thereby reducing the bus occupancy rate.

FIG. 33 is a diagram explaining about the simple loop splitting processing performed when a PreTouch instruction is inserted in a case where peeling is necessary.

Consideration is given to a case where a source program 512 shown in FIG. 33(a) is inputted. The source program 512 defines processing in which an operation result (multiplication result) of a loop count i and a variable val is sequentially assigned to elements of the array A. Note here that the size of each element of the array A is four bytes and is aligned to the cache size. More specifically, 32 elements of the array A are stored in one line of the cache. Also note that the iteration count of the loop included in the source program 512 is 140. As such, when the iteration count is divided by 32 which is the number of elements of the array A stored in one line, there will be a remainder left over.

In such a case, as shown by a program 514 in FIG. 33(b), the loop count left over as a remainder after 140 was divided by 32 is peeled off and the loop aside from the remainder is transformed into a double loop as is the case shown in FIG. 32(b). After this, the peeling folding processing is performed so that the peeled part is included into the double-loop structure. As a result, a program 516 as shown in FIG. 33(c) is obtained. To be more specific, the iteration processing is performed 32 times within the innermost loop in normal times whereas the iteration processing is performed 12 (=140-128) remaining times when the innermost loop is executed lastly. After this, as shown by a program 518 in FIG. 33(d), a cache area allocating instruction (PreTouch (&A[i])) is inserted prior to the execution of the innermost loop. Note that the area allocation processing is performed per line. For this reason, in the execution of the last innermost loop that has a possibility of allocating areas other than the object A, the PreTouch instruction is not issued so as not to allocate areas other than the object A.

[Structure Transformation Splitting by Insertion of Dynamic Alignment Analyzing Code]

FIG. 34 is a diagram explaining about the processing where misaligned array elements are dynamically specified to optimize the loop processing. Consideration is given to a case where a source program 522 shown in FIG. 34(a) is inputted. Here, the size of an element of the array A is four bytes.

Predetermined bits of a head address of the array A (address of an element A[0]) indicate a cache line, and out of these bits, another predetermined bits indicate an offset from the head of the line. Therefore, through a logical operation of bits called “A&Mask”, the offset from the line head can be derived. Note that the value of Mask is predetermined, and that it is set as [Mask=0x7F] in the present case. By subtracting the offset value, which was derived from the element address of the array A that is to be accessed in the first loop, from the value of Mask and then shifting the offset value to the right by a predetermined correction value Cor, the position of the element A[X] of the array A in relation to the head of one line can be determined. Thus, the number of misaligned elements PRLG in the line can be derived according to the following expression (4).
PRLG=(Mask−(&A[X])&Mask)>>Cor (4)

Moreover, according to the following expression (5), the position of the element (A[Y]) which follows the element (A[Y−1]) of the array A to be referenced lastly in the loop can be derived, with the position being determined in relation to the head of one line. Accordingly, the number of elements EPLG which do not fully fill one line can be derived.
EPLG=(&A[Y])&Mask)>>Cor (5)

Furthermore, the loop count KRNL with which the processing for one line is performed without leaving a remainder can be derived according to the following expression (6).
KNRL=(Y−X)=(PRLG+EPLG) (6)

To be more specific, as shown by a program 524 in FIG. 34(b), when the array A is allocated to a cache area, distinctions are made among: misaligned elements of the array A (A[X] to A[X+PRLG−1]); aligned elements of the array A (A[X+PRLG] to A[X+PRLG+KRNL−1]), the size of elements being a multiple of the size of one line; and aligned elements of the array A (A[X+PRLG+KRNL] to A[X+PRLG+KRNL+ERLG−1]), the size of the elements not filling one line.

Accordingly, processing such as calculation according to the expression (4) to obtain the number of misaligned elements PRLG of the array A is performed as shown by the program 524 in FIG. 34(b). Following this, the loop processing is performed for the misaligned elements of the array A (A[X] to A[X+PRLG−1]) in accordance with the number of elements PRLG. After this, for the aligned elements of the array A (A[X+PRLG] to A[X+PRLG+KRNL−1]), the double looping is performed as is the case with the simple loop splitting shown in FIG. 32(b). Moreover, when EPLG>0, the peeling processing is necessary, so the peeling processing is performed as with the case shown in FIG. 33(b) where the peeling processing is necessary.

After this, the folding processing is performed on the peeled loop. As a result, a program 526 shown in FIG. 34(c) is generated. Moreover, as shown in FIG. 34(d), by inserting a cache area allocating instruction (PreTouch(&A[i])), an optimized program 528 is obtained.

Note, however, that the area allocating instruction is inserted only in the aligned area and only for the innermost loop that uses an entire cache line.

### INDUSTRIAL APPLICABILITY

The present invention is applicable to processing executed by a compiler, an OS, and a processor, each of which controls issues of an instruction that has a possibility of causing an interlock.

1. A program conversion device for a processor which has an instruction set including an instruction that waits for a predetermined response from an outside source when the instruction is executed, comprising:
a loop structure transforming unit operable to perform double looping transformation so as to transform a structure of a loop, which is included in an input program and whose iteration count is x, into a nested structure where a loop whose iteration count is y is an inner loop and a loop whose iteration count is x/y is an outer loop; and
an instruction placing unit operable to convert the input program into an output program including the instruction by placing the instruction in a position outside the inner loop.

2. The program conversion device according to claim 1,
wherein said loop structure transforming unit includes:
a loop detecting unit operable to detect a loop included in the input program;
an iteration count detecting unit operable to detect an iteration count of the detected loop;
a response wait cycle count detecting unit operable to detect the number of response wait cycles which is the number of cycles to wait for the predetermined response when the instruction is executed;
a cycles-per-sequence detecting unit operable to detect the number of cycles per sequence required for one set of iteration processing of the detected loop;
a loop splitting unit operable to split off, from the detected loop, a loop whose iteration count is derived from (the number of response wait cycles/the number of cycles per sequence); and
a double looping transforming unit operable to perform double looping transformation so as to build a nested structure where the loop whose iteration count is derived from (the number of response wait cycles/the number of cycles per sequence) is an inner loop and a loop whose iteration count is derived from (the iteration count of the detected loop/the iteration count of the inner loop) is an outer loop.

3. The program conversion device according to claim 1, further comprising
an optimization directive information receiving unit operable to receive optimization directive information which relates to optimization.

4. The program conversion device according to claim 3,
wherein said optimization directive information receiving unit is operable to receive a minimum iteration count of the loop included in the input program,
said loop structure transforming unit is operable to, when an execution count of the loop is non-fixed, extract iteration processing having the minimum iteration count from the loop on the basis of the minimum iteration count and to perform double looping transformation on the extracted iteration processing of the loop.

5. The program conversion device according to claim 1,
wherein the instruction is an instruction that has a possibility of causing an interlock.

6. The program conversion device according to claim 5,
wherein the instruction that has a possibility of causing an interlock is a prefetch instruction for prefetching data from main memory to a cache.

7. The program conversion device according to claim 6, further comprising
a scheduling unit operable to perform instruction scheduling,
wherein said loop structure transforming unit is operable to split off, from the loop whose iteration count is x, a loop whose iteration count is y and which is executed corresponding to the number of cycles required to execute the prefetch instruction, based on a result obtained by said scheduling unit, and operable to perform double looping transformation so as to build a nested structure where the loop whose iteration count is y is an inner loop and a loop whose iteration count is x/y is an outer loop.

8. The program conversion device according to claim 1,
wherein after the instruction is executed, a plurality of cycles are required until a time comes when a predetermined resource will be referable.

9. The program conversion device according to claim 8,
wherein the instruction that requires the plurality is an instruction for accessing one of main memory and a cache.

10. The program conversion device according to claim 1,
wherein said loop structure transforming unit is operable to split off, from the loop whose iteration count is x, the loop whose iteration count is y and which is executed in accordance with an advance in a cache line size made by an address of an array referenced within the loop whose iteration count is x, and operable to perform double looping transformation so that the loop whose iteration count is y is an inner loop and the loop whose iteration count is x/y is an outer loop.

11. The program conversion device according to claim 10,
wherein when a plurality of arrays are present, said loop structure transforming unit is operable to further perform, in accordance with the number of the arrays, proportional dividing transformation to proportionally divide the loop whose iteration count is y and on which the double looping transformation has been performed.

12. The program conversion device according to claim 11,
wherein when sizes of array elements of the plurality of arrays are different, the loop whose iteration count is y is proportionally divided in the proportional dividing transformation in accordance with a ratio of the sizes.

13. The program conversion device according to claim 11,
wherein when each stride of the plurality of arrays is different, a stride referring to addresses advanced per set of the iteration processing of the loop, the loop whose iteration count is y is proportionally divided in the proportional dividing transformation in accordance with a ratio of the strides.

14. The program conversion device according to claim 11,
wherein when an inner loop is transformed, a conditional statement is generated for each divided loop and the proportional dividing transformation is performed so that each divided loop is executed within a same inner loop.

15. The program conversion device according to claim 10,
wherein when the loop whose iteration count is y is split off from the loop whose iteration count is x and a remainder z left over after a calculation of x/y is not zero, said loop structure transforming unit is operable to perform peeling processing and then double looping transformation on iteration processing that is to be executed z number of times.

16. The program conversion device according to claim 15,
wherein when the remainder z is not zero, said loop structure transforming unit is operable to generate a conditional statement for judging whether a loop count of an inner loop is y or z and to perform double looping transformation.

17. The program conversion device according to claim 10,
wherein when an execution count of a loop is non-fixed, said loop structure transforming unit is operable to judge the execution count of the loop when the loop is executed and to perform double looping transformation so as to dynamically vary an iteration count in accordance with a judgment result.

18. The program conversion device according to claim 10, further comprising
a receiving unit operable to receive information showing that arrays are aligned to a cache line size,
wherein said instruction placing unit is operable to place a prefetch instruction in the loop, whose iteration count is x, for prefetching data stored one cache line ahead of data to be referenced within the iteration processing of the loop that is executed x number of times.

19. The program conversion device according to claim 10,
wherein said optimization directive information receiving unit is operable to receive information showing a relative position in a cache line, from which the array starts to access,
said loop structure transforming unit is operable to perform the double looping transformation in accordance with the information.

20. The program conversion device according to claim 10,
wherein when the arrays are not aligned to the cache line size, said instruction placing unit is operable to place a prefetch instruction in the loop, whose iteration count is x, for prefetching data stored two cache lines ahead of data to be referenced within the iteration processing of the loop that is executed x number of times.

21. The program conversion device according to claim 10,
wherein when the arrays are not aligned to the cache line size, said loop structure transforming unit is operable to judge a relative position in a cache line, from which the array starts to access, and operable to perform double looping transformation in accordance with a judgment result.

22. The program conversion device according to claim 10, further comprising
a receiving unit operable to receive information that relates to a focused array,
wherein said loop structure transforming unit is operable to perform double looping transformation only on the focused array.

23. The program conversion device according to claim 1,
wherein said loop structure transforming unit is operable to further perform double looping transformation on an outer loop, considering an innermost loop as one block.

24. A program conversion method for a processor which has an instruction set including an instruction that waits for a predetermined response from an outside source when the instruction is executed, comprising:
a step of performing double looping transformation so as to transform a structure of a loop, which is included in an input program and whose iteration count is x, into a nested structure where a loop whose iteration count is y is an inner loop and a loop whose iteration count is x/y is an outer loop; and
a step of converting the input program into an output program including the instruction by placing the instruction in a position outside the inner loop.

25. A program realizing a program conversion method for a processor which has an instruction set including an instruction that waits for a predetermined response from an outside source when the instruction is executed, the program causing a computer to execute:
a step of performing double looping transformation so as to transform a structure of a loop, which is included in an input program and whose iteration count is x, into a nested structure where a loop whose iteration count is y is an inner loop and a loop whose iteration count is x/y is an outer loop; and
a step of converting the input program into an output program including the instruction by placing the instruction in a position outside the inner loop.
